(19) United States
(12) Patent Application Publication
(10) Pub. No.: US 2003/0182225 A1
(43) Pub. Date: Sep. 25, 2003

(54) Machine-implementable project finance analysis and negotiating tool software, method and system

(76) Inventor: Wilfried A. Maestle, Washington, DC (US)

Correspondence Address: CROWELL & MORING LLP, Intellectual Property Group, P. O. Box 14300, Washington, DC, 20044-4300, US

(21) Appl. No.: 09/781,964

(22) Filed: Feb. 14, 2001

Related U.S. Application Data
(63) Continuation-in-part of application No. 09/676,248, filed on Sep. 29, 2000.

(51) Int. Cl. G06F 17/60

(52) U.S. Cl. 705/38

(57) ABSTRACT

A financial simulation computer program product and method to generate a graphic user interface at a workstation which creates a project preparation, negotiating, and testing environment using standard project finance tools. A computer usable medium having computer-readable program code is embodied in a medium for generating financial statements, financial data, charts, graphs and reports using the standard project finance tools. The product and method allow the user to automatically generate and manually edit one variable interest rate time series (scaleable to more reference variable interest rate time series as computing power increases). The user can also choose for an individual loan a fixed interest rate, a variable interest rate or a manual interest rate. A three-stage production process can be specified. An intermediate product can be used as input for next stage or can be sold. Intermediate produce can be procured to prevent production losses due to shortfall of intermediate product. Furthermore, a joint production process can be specified.

### CROSS-REFERENCE TO RELATED APPLICATION

This application is a continuation-in-part of my patent application filed on Sep. 29, 2000, under Ser. No. 09/676,248 (our Ref: 2091/49088) referred to in the following as the “Parent Application”, the contents of which are herein incorporated by reference.

### COMPUTER PROGRAM LISTING APPENDIX

I attach on CD-ROM, as a supplement to the first Microfiche Appendix of the Parent Application modifications/extensions to my computer program listing, and a supplement to the second Microfiche Appendix (Flow Chart and Graph Appendix of the Parent Application) of flow charts.

### BACKGROUND OF THE INVENTION

In the machine-implementable project finance analysis and negotiating tool (also referred to by the acronym “PFANT”) as subject to the Parent Application, interest simulations were based on an interest rate that was fixed from loan effectiveness to full loan repayment. While fixed interest rate loans are often preferable as interest amounts due in the future can be predicted with certainty, commercial fixed interest rate loans are often not available to borrowers in need of long-term finance. In conventional financial modeling spreadsheet software variable interest rate fluctuations can be manually coded into the spreadsheet making the simulation laborious and error prone as applicable interest rates for individual project loans should only change at rollover dates and should be constant between such dates. To date, there exists no project finance software package with an easy to use graphical user interface that creates a project preparation, negotiating and testing environment with the standard project finance tools (debt service reserve accounts, sweep, stand-by loans, deferral credits for inputs and off-take fees, input price as a function of sales price) that allows the automatic variable interest rate generation, editing and simulation, nor does such a software package exist that permits manual interest rate entries for individual loans strictly limited to rollover dates.

The PFANT as described in the Parent Application allows the simulation of a single-stage production process (scalable, but limited at this time to three products due to restrictions of computing power). While a single-stage production process has many applications in real life, other production processes require the joint production of different products and/or multiple production stages. To date, however, there exists no project finance software package that creates a project preparation, negotiating and testing environment with the standard project finance tools that allows a non-financial modeler the simulation of a joint production or a multi-stage production process.

### SUMMARY OF THE INVENTION

In addition to the capabilities of the PFANT, as fully described in the Parent Application, the upgraded PFANT described herein allows the user to:

automatically generate and manually edit one variable interest rate time series (scaleable to more reference variable interest rate time series as computing power increases);

choose for an individual loan a fixed interest rate (as before), a variable interest rate or a manual interest rate;

The new multi-stage version of the PFANT of the present application allows the user to:

specify a three-stage production process (scaleable within the scope of the present invention to multi-stage, multi-product process as computing power increases);

use intermediate product as input for next stage or sell it;

procure intermediate product to prevent production losses due to shortfall of intermediate product.

The new joint production version of the PFANT allows the user to:

specify a three-product joint production process (i.e., one production process for main and joint products) (scalable within the scope of the present invention as computing power increases).

This present invention achieves a major step forward in financial modeling technique.

### BRIEF DESCRIPTION OF SUPPLEMENTAL DRAWINGS

FIG. 1 is a representative flow chart from the variable interest rate data subset showing the routine of entering the variable interest rate time series.

FIG. 2 is a representative flow chart of an intermediate product use entry routine for the intermediate product data subset.

FIG. 3 is a representative flow chart of a product delete routine for a joint production process.

### DETAILED DESCRIPTION OF THE DRAWINGS

I am defining below the additional terms used throughout and in a manner which I believe to be generally consistent with normal and customary usage. To the extent there are any discrepancies, the following terminology should control the interpretation of my description. Furthermore, a more complete description of the routine is found in the CD Appendix containing the supplement to the second Microfiche Appendix (Flow Chart and Graph Appendix of the Parent Application), notwithstanding the fact that the essential disclosure to enable a person of ordinary skill to make and use the invention is fully described herein below.

Supplement to Terminology of the Parent Application

Basis Point

One hundredth of one percent (1/100%). Variable interest rates usually refer to a widely recognized interest rate such as the LIBOR. For example, a prospective debtor is supposed to pay 1.3% more interest than LIBOR. This equals 135 basis points.

Intermediate Product

A product produced by a previous production stage that is used as input in the next production stage. For example, iron ore is needed to produce pig iron. Pig iron is needed to produce steel. Pig iron is an intermediate product for steel production.

LIBOR

Acronym for London Interbank Offered Rate. Average rate at which banks in London place Euro dollars with each other.

Roll-over Period

The rollover period is the time from one rollover date to the next. If the variable interest rate to which a loan interest rate refers has changed since the last rollover, the loan interest rate for the next rollover period will change accordingly. For example: during rollover period one the borrower has to pay LIBOR+90 basis points. At the start of rollover period one LIBOR is 5.2%. The borrower pays 6.1%. Assume that at the end of the rollover period LIBOR has reached 5.5%. The borrower then pays 5.5%+90 basis points or 6.4% interest in rollover period two.

I. Supplement to General Overview

The PFANT software describes each project finance deal by a set of data that the user enters into a case file spreadsheet. A list of the variables comprising such a set of data was submitted in Table I. of the Parent Application. A list of supplementary data required to accommodate the enhanced interest rate, multi-stage and joint production capabilities is found in the following supplement to Table I.

SUPPLEMENT TO TABLE I

| | | | |
|---|---|---|---|
| Data | Optional - Required | Default | Impact of Default |

TECHNICAL SPECIFICATIONS

| | | | |
|---|---|---|---|
| Multi Stage Production Process | | | |
| Input-Output Coefficient for | Required | Zero | Output of previous stage not required as input. |
| Intermediate Product | | | |
| (Only End Product Stage and 2^{nd} | | | |
| Stage) | | | |
| Joint Production Process | | | |
| Units of Joint Product per Unit of | Required | Zero | Output of joint product is zero. |
| Main Product | | | |
| Share in Production Cost | Required | Zero | Total production cost allocated to main product. |

LOANS

| | | | |
|---|---|---|---|
| Bank Loans | | | |
| Interest Type | Required | Fixed | Interest rate is fixed. |
| | | Interest | |
| | | Rate | |
| Interest p.a. - % | Optional | Zero | No interest payments. |
| (with selection Fixed | | | |
| Interest Rate) | | | |
| Basis Points (+) or (−) | Optional | Zero | No basis points added or subtracted from project |
| (with selection Variable | | | wide reference variable interest rate. |
| Interest Rate) | | | |
| Manual interest rates | Optional | Zero | No interest payments. |
| (with selection Manual | | | |
| Interest Rate) | | | |

STAND BY LOANS, SWEEP

| | | | |
|---|---|---|---|
| Stand by Loans | | | |
| Interest Type | Required with | Fixed | Interest rate fixed, |
| | Standby Loan | Interest | |
| | | Rate | |
| Interest - % p.a. | Optional | Zero | No interest payment. |
| (with selection Fixed | | | |
| Interest Rate) | | | |
| Basis Points (+) or (−) | Optional | Zero | No basis points added or subtracted from project |
| (with selection Variable | | | reference variable interest rate. |
| Interest Rate) | | | |

VARIABLE COSTS

| | | | |
|---|---|---|---|
| Variable Cost determined | | | |
| by Input Market | | | |
| Unit of Measurement | Required with variable costs | Empty | You cannot enter variable cost |
| | (Only if procured input is not | | (in case of intermediate good shows unit |
| | intermediate good) | | of measurement entered for intermediate |
| | | | good under Technical Specifications) |
| Input - Output Coefficient | Required with variable costs | Empty | You cannot enter variable cost. |
| | (Only if procured input is not | | (in case of intermediate good shows unit |
| | intermediate good) | | of measurement entered for intermediate |
| | | | good under Technical Specifications) |
| Flexible Input Pricing | | | |
| Interest Type | Required with Deferral Credit | Fixed | Interest rate is fixed. |
| | | Interest | |
| | | Rate | |
| % - Interest p.a. on | Optional | Zero | No interest on deferral - loan. |
| deferred Amount | | | |
| (with selection Fixed Interest | | | |
| Rate) | | | |
| Basis Points (+) or (−) | Optional | Zero | No basis points added or subtracted from project |
| (with selection Variable | | | wide reference variable interest rate. |
| Interest Rate) | | | |

SALES

| | | | |
|---|---|---|---|
| Intermediate Products | | | |
| % of Intermediate | Required | Zero | All output of intermediate product sold. |
| Product available as Input | | | No intermediate product |
| | | | used as input for next production stage. |
| Commodity Market Pricing | | | |
| Interest Type | Required with Deferral Credit | Fixed | Interest rate fixed. |
| | | Interest | |
| | | Rate | |
| % - Interest on Deferred | Optional | Zero | No interest on deferral-loan. |
| Amount | | | |
| (with selection Fixed Interest | | | |
| Rate) | | | |
| Basis Points (+) or (−) | Optional | Zero | No basis points added or subtracted from |
| (with selection Variable | | | project wide reference variable |
| Interest Rate) | | | interest rate. |

II. Supplement to Modules

1. Enhanced Interest Rate Capabilities

A. Variable Interest Rate Data Subset

The user can generate manually or automatically a variable interest rate time series as a project wide reference interest rate. The variable interest rate can be used with general-purpose loans, standby loans and deferral credits provided by off-takers and/or suppliers. The user refers to the variable interest rate by adding or subtracting basis points as the case may be. Changes to the variable interest rate are automatically reflected in all loans that use the variable interest rate as a reference. This allows the user to assess quickly the impact of a variable interest rate change.

Automatic and Manual Interest Rate Generation Method

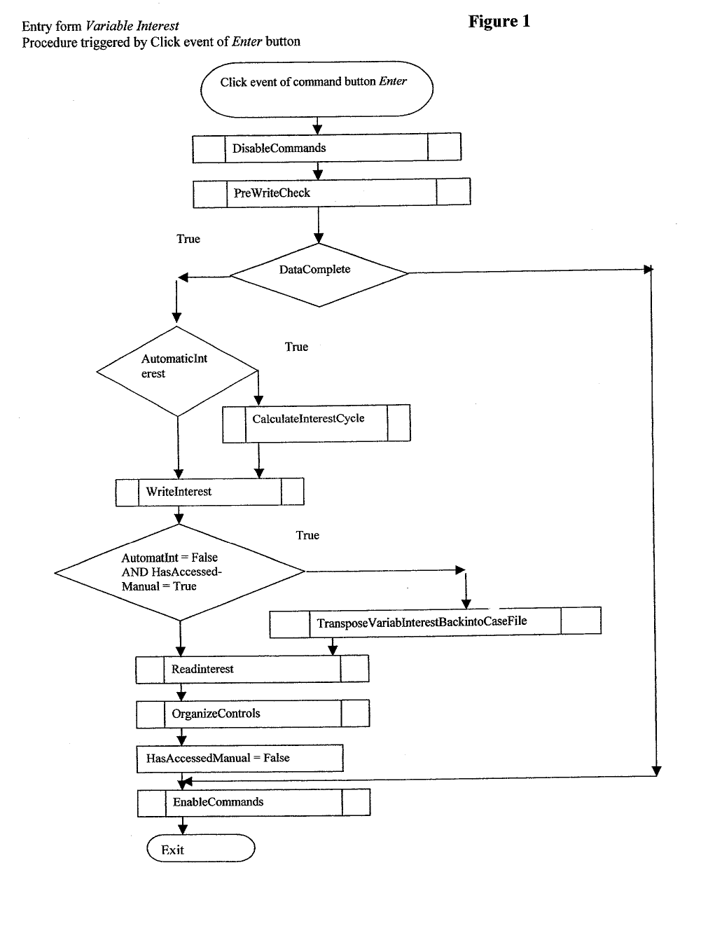

The upgraded PFANT features two methods to generate the variable interest rate: automatically or manually. An interest rate time series can be automatically generated and edited as necessary to allow any conceivable interest pattern. Once generated, a variable interest rate time series is entered into the case file using the procedure in FIG. 1.

If the user opts for automatic interest rate entries, she can establish an interest rate trend and freely select the first and last trend month. The user is allowed to generate interest rate fluctuations around a long-term interest rate trend. The program uses a sine function to simulate interest rate volatility. Both the length of the interest rate cycle and the amplitude of the interest rate swings around the long run interest trend can be influenced. In case of interest rate volatility, the user can set the interest rate at project start as

Half way up (default)

Top Interest

Half way down

Bottom Interest

While the PFANT in its present embodiment is restricted to one project wide variable interest rate, it is possible without great modifications to make available more variable interest rates as computing power increases without departing from the scope of the present invention.

Across the Board Variable Interest Rate Change Method

The user can perform automatically across the board changes to the variable interest rate time series (e.g. add or subtract 150 basis points). The PFANT prevents negative interest rates.

B. General Purpose Loans

The user can use one of three interest rate types:

Fixed interest rate (as of the Parent Application)

Variable interest rate

Manual interest rate.

Variable Interest Rate

After having called an individual loan record into the graphical user interface, the user can select the option Variable Interest Rate. She can enter the number of basis points that the PFANT has to add or subtract (if the borrower has to pay less than the prime rate) from the variable interest rate. The PFANT updates the loan interest rate at interest payment dates (rollover dates). The PFANT prevents negative interest rates. Between rollover dates, the loan interest rate is constant.

Manual Interest Rate

The user can design for each general-purpose loan a manual interest time series. The program allows the user to enter for each rollover date an interest rate that is applicable up to the next rollover date. The PFANT prevents negative interest rates. She can thus design any conceivable interest pattern for an individual general-purpose loan.

Permitted Combinations

In case of an annuity, the interest rate has to be fixed. The PFANT prevents illegal combinations of interest and repayment types for general-purpose loans. The following combinations are allowed:

| Allowed combinations | | |
|---|---|---|
| Disbursement Method | Repayment Method | Interest Types |
| Automatic disbursement | Equal installments | Fixed Interest Rate |
| | | Variable Interest Rate |
| | | Manual Interest Rate |
| | Annuity | Fixed Interest Rate |
| Manual disbursement | Equal Installments | Fixed Interest Rate |
| | | Variable Interest Rate |
| | | Manual Interest Rate |
| | Annuity | Fixed Interest Rate |
| | Manual Repayment | Fixed Interest Rate |
| | | Variable Interest Rate |
| | | Manual Interest Rate |

C. Other Loans Provided by the PFANT

The upgraded version of the PFANT adds a variable interest rate option. If the user opts for a variable interest rate she can add or subtract basis points from the project wide variable interest rate. While the present embodiment of the PFANT with respect to

Stand by loans

Deferral credits for inputs (variable costs—determined by sales receipts)

Deferral credits for off-taker fees (Sales Contract Type 1)

is restricted to fixed and variable interest rates, a manual interest rate feature could easily be added later according to the principles established under general purpose loans above within the contemplated scope of the present invention.

III. Multi-Stage Production Function

A. Technical Specifications—The Production Function Data Set

The Parent Application is based on a single-stage production process. While a single-stage production process is adequate for a substantial number of applications, other production processes call for a multi-stage approach. As an alternative to and in addition to the single-stage PFANT, the multi-stage version of the PFANT was developed. The multi-stage version comprises all the features of the single-stage PFANT and differs only with respect of the production function.

Due to memory restrictions, the multi-stage PFANT software is currently restricted to a three-stage process with an entry stage, whose intermediate output is used as input in a second stage, whose intermediate output is used as input in the end product stage. As more computing power becomes available, it should be easy to scale up the program to include more production stages and multiple end products within the contemplation of the present invention.

B. Input-Output Coefficient Intermediate Products

The user can enter an input output coefficient for the present production stage-regarding its requirements for the intermediate product produced by the previous production stage. For example, previous production stage blast furnace, output pig iron. Present production stage basic oxygen process, output steel. Input output coefficient 63 parts of intermediate product pig iron for 100 parts of end product steel or 0.63.

C. Automatic and Manual Intermediate Product Usage Time Series Generation Method

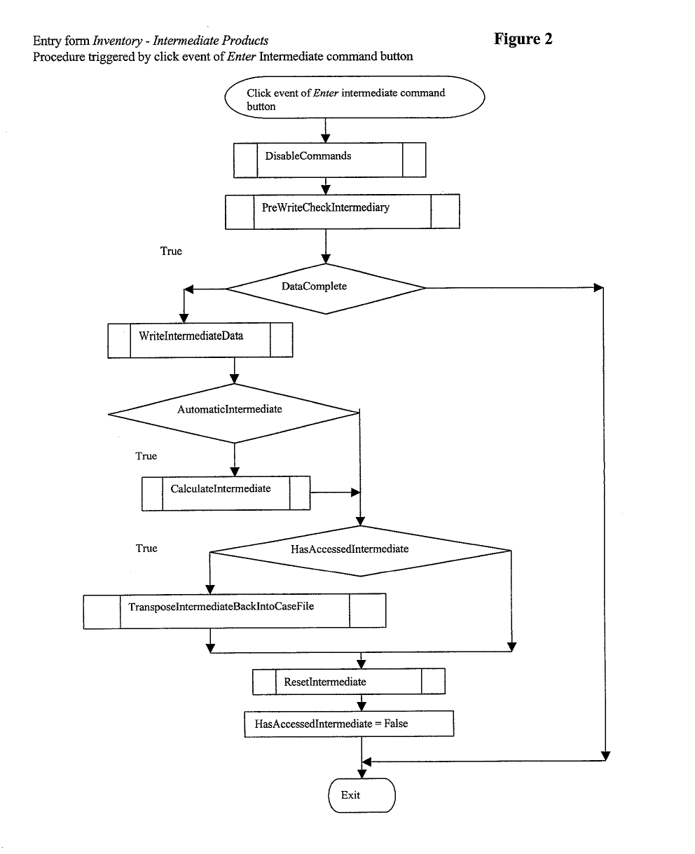

The user can decide for each month during the project lifetime how much of an intermediate product is sold or used as input for the following production stage. The multi-stage PFANT features two methods to generate an intermediate product usage time series: automatically or manually. A time series can be automatically generated and edited as necessary to allow any conceivable usage pattern. The user writes the time series into the case file using the procedure in FIG. 2.

D. Closing an Intermediate Product Gap

Based on the installed capacity, her choice of a learning curve, the capacity usage and necessary maintenance shutdowns, the user establishes a production possibility frontier. Whether the frontier is reached, depends on the availability of the intermediate product. An underutilization of a production stage can be caused by lack of sufficient intermediate output of the previous stage, or failure to use the intermediate product as input in the following production stage. The user can accept the temporary or permanent shortfall of an intermediate product as intended or procure the intermediate product using an adapted version of the Type 1: Variable Costs—Determined by Prices in the Input Market method as described in the Parent Application. However, the PFANT prevents her from entering an input output coefficient and a measurement unit for the intermediate product, as both have been entered as part of the Production Function Data Set. She can use multiple (up to three) procurement contracts per intermediate product, with each of the contracts closing the input gap and the multi-stage PFANT preventing that more of the intermediate product is procured than required. The program buys the intermediate product only if there is a gap.

While the multi-stage PFANT in its present embodiment uses an adapted version of the Type 1: Variable Costs—Determined by Prices in the Input Market method, it could be easily adapted to use the Type 2: Variable Costs—Determined by Sales Receipts method as also described in the Parent Application.

E. Sales

The user can sell an intermediate or end product using any of the types of sales contracts described in the Parent Application for the PFANT. The following modifications apply:

(i) Inventory Cycles

As described in the Parent Application, the PFANT allows the user to set for each product an inventory cycle. In case of an intermediate product, the inventory cycle is the time an intermediate product is kept in stock before it is either sold or used as input in the next production stage.

(ii) Voluntary and Forced Sales

If a previous production stage produces more intermediate products than the following stage can use, the PFANT sells the excess intermediate output. Such a forced sale can be temporary, caused e.g. by a maintenance shutdown, or permanent, in case of a mismatch of installed capacity.

III. Joint Production Process Function

A. Technical Specifications—The Production Function Data Set

While single- and multi-stage production processes with each production stage turning out only one product fit many applications well, other production processes result in a number of products being produced jointly. As an alternative and in addition to the single- and multi-stage versions of the PFANT a joint production version has been developed. The joint production version of the PFANT comprises all the features of the single-stage PFANT and differs only with respect to the production function.

Due to memory restrictions the joint production PFANT software is currently restricted to a three joint products single-stage production process (main product plus two joint products). As more computing power becomes available, it should be easy to scale up the program to create any combination of production stages and multiple joint or single products without departing from the scope of the present invention.

B. Units of Joint Product Produced per Unit of Main Product

Once the user has entered a main product following a procedure described in the Parent Application for the entry of a product, she can enter the names of additional products jointly produced with the main product. However, the GUI does not show entry fields for technical specifications such as capacity usage, learning curves, or time needed to produce one unit of output as such data are only entered once (with the main product data) for the joint production process. However, the user can enter the number of units of the additional product produced per unit of main product. For example, a joint production process turns out two parts of the main product and one part of a joint product. The number of units of the additional product produced per unit of the main product is ½.

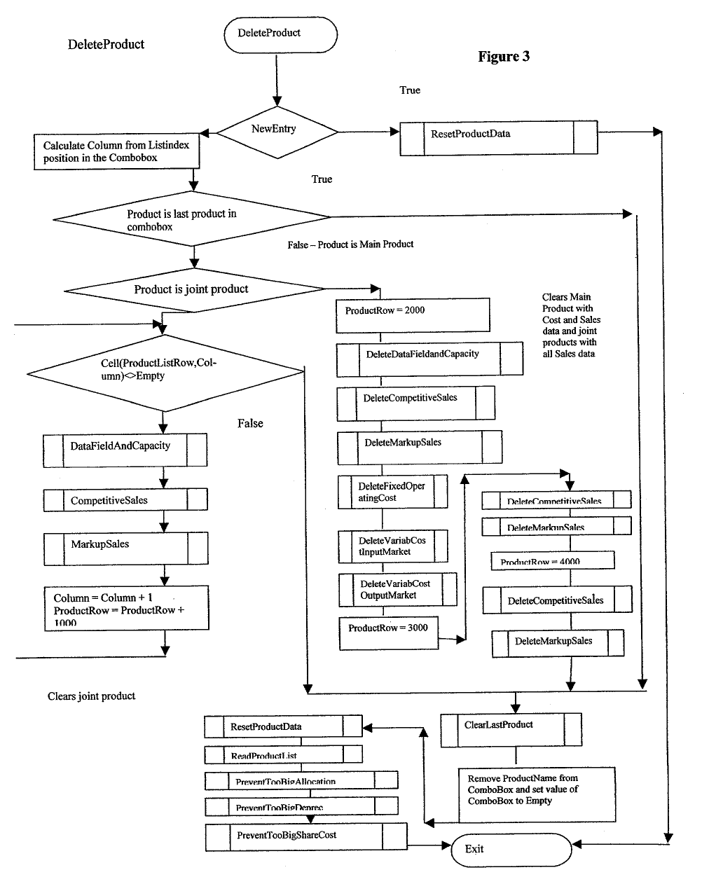

If the user deletes the main product using the delete procedure as described in FIG. 3, all entries regarding main or joint products are removed. If the user deletes a joint product, only the entries regarding the joint product are removed.

C. Allocation of Production Cost

The user can enter variable cost and fixed operating cost caused by a joint production process following the procedures described in the Parent Application. She can enter such cost only once, and only for the main product. However, the user can allocate all or part of such production cost to a joint product. Production costs not allocated to joint products are automatically allocated to the main product. The PFANT ensures the full and prevents an over allocation of production cost.

Overheads and depreciation are allocated to the main and joint product(s) according to the user's specifications.

D. Sales

The user can set for each main or joint product an individual inventory cycle and can sell a main or joint product using any of the types of sales contracts described in the Parent Application.

The following description discloses an excerpt of Chapter 4 (Global) as modified for the joint production process version of the PFANT, a revised Chapter 6 (Loans, taking into account the increased interest rate capabilities and applicable to all versions of the PFANT) and Chapter 10 (Variable Costs, modified for the multi-stage version) of the proposed user's guide. Following the chapters, I have set out two supplemental examples to project finance modeling using the multi-stage and joint production versions of the PFANT. Supplemental Example I maps out an iron ore beneficiation pellet plant as entry stage, a blast furnace that produces pig iron as second stage, and a basic oxygen process that produces steel as an end product stage. Supplemental Example II describes a distillation process with gasoline, diesel and bitumen as joint products. Coefficients and prices are fictitious.

### CHAPTER 4

### ProFinTools Project Finance—Global Data

Extract of Proposed Chapter

Technical Specifications

Main Product Name, Joint Product Name

The program allows you to produce a main product and up to two joint products with a single stage linear production process. Start with the main product and enter the name of the main product at the top of the frame Technical Specifications (on the entry form Global Project Data) in the box Product Name. Before you press Enter, fill in the other entry fields in the frame. For the joint products do the same. Note, that once you have created a main product, the graphical user interface shows you only a much reduced number of entry fields. Most technical information you only have to enter once as the joint production process is mostly described with the technical data entered with the main product.

Measurement Unit Output

ProFinTools Project Finance uses a linear production function for the joint production process. Enter the unit that is used to measure the output (for example tons, gallons etc.). All later entries that refer to the output of the main or joint product (like variable inputs per unit or sales prices) refer to this unit of measurement.

Maximum Capacity

Enter the maximum number of units of the main product that the plant is physically able to produce per year. For example: if the plant can produce 1,000,000 units of the main per year, enter 1000000 for product 1. The entry box is not visible if you enter or select a joint product.

Actual Capacity Usage

Enter the actual capacity usage. For example, enter 95 while entering the main product if capacity usage is 95%. To determine the number of units produced per month the program divides the annual maximum capacity by twelve and multiplies the monthly maximum output by the actual capacity usage. The entry box is not visible if you enter or select a joint product. The actual capacity usage entered for the main product applies to the joint products as well.

Maintenance

What about regular maintenance shutdowns? Assume your plant works at 97% of the maximum capacity through the year but needs a two-week annual maintenance shutdown every August.

1 Enter 97 (for 97%) as Actual Capacity Usage (while entering main product).

2 Complete the other entries on the Global Project Data entry form.

3 Press Enter. The program writes the capacity use into the case file.

4 Select as learning curve Manual and press Edit Capacity Use. The program will show you the capacity use from start-up on.

5 Select every August until the end of the project life. Enter for each August 50 (for 50%). Press Return and then Enter to write the changes you make into the case file.

Learning Curves

If your plant needs to be run in, production after start-up of operations will not immediately reach the average capacity usage. ProFinTools Project Finance allows you to automatically generate a

Linear Learning Curve

Production increases during the learning period monthly by equal amounts.

Steep Learning Curve

Production increases steeply at the beginning of the learning curve. Later, the learning curve levels off.

Flat Learning Curve

Production is flat at the beginning and steep later on.

Checklist: Create a Learning Curve

1 Select the main product.

2 Enter the Actual Capacity Usage

3 Select a learning curve (click, selection should turn blue). Enter the Capacity Use at Start-up−% (of operations) and define the length of the learning period.

4 Press Enter.

Checklist: Edit or Look at a Learning Curve.

1 Go first through the steps 1-4 above (this saves you a lot of typing).

2 Select the main product in the Product Name box.

3 Click on Manual in the Manual/Learning curve listbox (selection should turn blue). A button titled Edit Capacity Use will pop up.

4 Press Edit Capacity Use. The program shows you the learning curve.

5 Edit.

6 Press Return when done.

7 Press Enter to write the data into the case file.

Checklist: Look at or Publish the Monthly Output

1 Exit the form Name, Schedule and Technical specifications.

2 On the menu bar select Model and then Show Me. The program loads the output system.

3 Press the command button Cost of Goods. The frame Costs will pop up. Click with the mouse on the product you want to study. Four comboboxes will appear. Click in the lowest box on Capacity Use—Learning Curve. Then press either Show Me or Publish. The program loads the corresponding cost file.

Units of Joint Product per Unit of Main Product

If you enter or select a joint product, the program shows you the Units of Joint Product per Unit of Main Product box. The program needs to know how many units of the joint product are produced per unit of output of the main product.

Assume you operate a distillation plant with crude oil as input and gasoline, Diesel and bitumen as output. Assume you need 1 part of crude oil to produce 0.6 parts of gasoline, 0.3 parts of Diesel and 0.1 parts of bitumen. For the joint product Diesel write 0.5 into the Units of Joint Product per Unit of Main Product box (0.3 parts/0.6 parts). For bitumen write 0.16666 into the box (0.1 parts/0.6 parts).

Note: The Units of Joint Product per Unit of Main Product box is only visible if you enter or select a joint product.

Production Time/Unit of Output (Time Needed to Produce One Unit of Output)

To calculate work-in-progress the program needs to know the time it takes to produce one unit of output. The longer it takes to produce one unit of output, the higher is the value of work-in-progress at any given time. Production can be instantaneous, as for example in the case of an electrical power plant. In that case, the fields Days, Hours, Minutes and Seconds should be left with their default values zero. The fields Days, Hours, Minutes and Seconds are only visible if you enter or select a main product.

Share in Production Cost

The share in production cost is the percentage of production cost allocated to a joint product. Write the percentage you want to allocate to a joint product into the Share in Production Cost % box. For example: if you want to allocate 20 percent, write 20. The program treats all production cost not allocated to the joint products as production costs of the main product.

Note: The Share in Production Cost box is only visible if you enter or select the main product.

Share in Overheads

The share in overheads is the percentage of overheads allocated to the main or joint product. Overheads are maintenance, administrative costs, factory overheads and insurance that not directly related to the production of the good. Write the percentage allocated to the product into the Share Overheads−% box. This is only important if you intend to sell the end product or an intermediate product on a mark up or cost plus basis.

Share in Depreciation

The share in depreciation and amortization is the percentage of the total depreciation and amortization allocated to the product in any project month. The program needs this information for mark-up pricing.

### CHAPTER 6

### ProFinTools Project Finance—Loans

This chapter deals with loans available under ProFinTools Project Finance. The program allows you to use up to six general-purpose loans to finance whatever needs arise. Further, the program automatically generates supplier credits if capital expenditure is not fully paid at start-up of operation. Finally, a stand-by loan is available for the construction and repayment phases as limited recourse instruments.

Variable Interest Rate

ProFinTools Project Finance allows you to set a variable interest rate per year as a project wide reference. You can use the variable interest rate with general-purpose loans, standby loans and deferral credits provided by off-takers and/or suppliers. However, as interest rates for loans in different currencies usually differ, you should restrict the use of the variable interest rate to one loan currency. Different loans refer to the variable interest rate by adding or subtracting basis points as the case may be. Changes to the variable interest rate are reflected in all loans that use the variable interest rate as a reference. This allows you to assess quickly the impact of an interest rate change.

ProFinTools Project Finance allows the simulation of variable interest rate trends, fluctuations and shocks. You can edit the interest rate to generate any conceivable interest pattern. Further, the program permits you across the board changes to the interest rate (for example plus 150 basis points).

Create Variable Interest Rate Time Series

You can generate the time series automatically or manually.

1. Automatic Interest Rate

If you select the option Automatic Interest Rate the program allows you to generate the variable interest rate time series automatically. This saves a lot of typing.

Interest Rate

Write the interest rate per year into the Interest p.a.−% box. Example: if the interest rate is 5.5% write 5.5. If you want a constant variable interest rate (no interest rate variations) you can accept the default values for interest trend and volatility and press Enter.

Interest Trend (+) or (−)

If the variable interest rate increases, enter a positive number. For example, if the interest rate goes up 10% per year, write 10 into the Interest Rate % p.a. box.

For variable interest rate decreases, enter a negative number. For example, if the interest rate goes up 10% per year, write 10 into the Interest Rate % p.a. box.

Last Trend Month

Select the Last Trend Month. The program allows you to end the trend at any project month lower than month 254. The default setting is month one.

Percent Volatility

Enter the percentage of up and down swings of the variable interest rate around the long-run interest rate trend. This entry determines the amplitude of the interest rate swings. For example, if you want your variable interest rate to go up and down by 10% during an interest rate cycle, enter 10.

Month Length of Cycle

A sine curve is used to simulate interest rate volatility. You can influence both the length of an interest rate cycle and the amplitude of interest rate swings around the long-run interest rate trend. The default length of the interest rate cycle is 60 months.

Status at Project Start

Select on of the following options for your variable interest rate at project start (click, selection should turn blue).

Halfway up (default)

Top Interest

Halfway down

Bottom Interest

One Time Interest Rate Shock

For an interest rate increase, enter a positive number, for an interest rate decrease enter a negative number. For example, if the interest rate is to increase by 10 percent, enter 10.

Month of One Time Shock

Select the month in which the interest rate shock occurs with the spin button Month of One Time Shock (for example, select 36 for a shock that occurs three years after project start).

2. Manual Interest Rate

You can either create a variable interest rate time series manually from scratch or you can edit a time series generated with the automatic interest rate feature. ProFinTools Project Finance allows you to edit the variable interest rate time series. If you select the option Manual Interest Rate the entry fields that allow you to design the automatic interest rate time series disappear. Instead, you get access to the Edit Interest Rate command button. Press the Edit Interest Rate button to go to the interest rate time series.

Across the Board Changes to the Variable Interest Rate

ProFinTools Project Finance allows you to make easy across the board changes to the interest rate time series:

You can change an automatically created time series by typing a different interest rate into the Interest Rate % p.a. box and then pressing Enter.

You can add or subtract basis points to a manually generated interest rate time

series. For that feature select Manual Interest Rate. At the right side of the entry form the box

Add/Subtract Basis points pops up.

Enter the number of basis points you want to add or subtract. For example, if you want to increase the variable interest rate across the board by 1.35%, enter 135. If you want to decrease the interest rate across the board by 2.3%, enter −230 (minus 230). The program will reduce the interest rate by 230 basis points but not below zero percent.

You can combine the automatic and manual methods and start out with an automatic interest rate, edit the time series manually and then add or subtract basis points.

Checklist: Simulate a Variable Interest Rate

1 On the general menu select Loans and on the drop down menu Variable Interest Rate.

2 Select the option Automatic Interest Rate

3 Enter interest rate into the Interest Rate % p.a. box.

4 Press Enter or proceed to 5.

Checklist: Optional—In Case You Want to Simulate a Variable Interest Rate Trend

5 Write the percentage of the interest rate trend into the Interest Trend (+) or (−) box.

6 Select the last month of the trend.

7 Press Enter or proceed to 8.

Checklist: Optional—In Case You Want to Simulate Variable Interest Rate Volatility

8 Write the percentage of the interest rate swings (interest rate increase and interest rate decrease) into the Percent Volatility box.

9 Select the length of the interest rate cycle with the spinbutton.

10 Select the status of the interest rate with the spinbutton (Half-way up, Top Interest, Half-way down or Bottom Interest).

11 Press Enter or proceed to 12.

Checklist: Optional—In Case You Want Simulate a One-time Interest Rate Shock

12 Write the percentage figure of the one time shock into the One Time Interest Rate Shock (+) or (−) box.

13 Select with the spinbutton the month of the one time interest rate shock.

14 Press Enter.

Checklist: Design Manually a Variable Interest Rate Time Series

1 On the general menu select Loans and on the drop down menu Variable Interest Rate.

2 Select option Manual Interest Rate (to save typing you can go through steps 1-14 above to establish a time series that you can edit).

3 Press the command button Edit Interest Rate.

4 Edit earlier entries or write interest rate for each month. Press Return when you are done.

5 Press Enter.

Hint: You can always switch back to the automatic variable interest rate design. However, you loose your manual entries.

Checklist: Across the Board Change of Interest Rate

1 On the general menu select Loans and on the drop down menu Variable Interest Rate.

2 Before you can make any across the board changes, you have to access the time series. Select option Manual Interest Rate and press the Edit Interest Rate command button. Then press Return once you are satisfied with the trend.

3 Press the left bottom corner Enter button.

4 Write the basis points you want to add (+) or subtract (−) into the Add/Subtract Basis points box on the upper right.

5 Press Enter. If you want to study the changes press Edit Interest Rate.

Delete the Variable Interest Rate

1 Select Loans on the general menu bar.

2 Select Variable Interest Rate on the drop down menu.

3 Press Delete. The interest rate time series will be set to zero.

Checklist: Look at or Publish the Variable Interest Rate

1 After you have established a variable interest rate exit form Variable Interest Rate

2 On the general menu bar, select Model and on the drop down menu Show Me.

3 Press Loans. A list box appears. Select Variable Interest Rate.

4 Press Show Me if you want to see the variable interest rate and associated graph. Else, press Publish.

General-Purpose Loans

General-purpose loans allow you to inject loan funds into the company whenever you want. The program generates disbursement and repayment schedules. If the project ends before the loan is fully repaid, the balance sheet will show you the utilization of the loan for the month before the end of the project. Interest payments then turn to zero. The loan output system (press Model on the general menu bar and then Show Me and Loans) will provide you with the loan data as if funds were completely repaid regardless to the end of project life.

ProFinTools Project Finance presents to you a two-page entry form for general-purpose loans (on the general menu bar press Loans and then Bank Loans). On Loan Page One you find financing, as well as disbursement and repayment schedules. On Loan Page Two, you find general loan data and the debt service reserve accounts (DSRA.). You should first fill in Loan Page One. To generate a loan you have to take four steps:

1. Establish what you want to finance (Loan Page One)

2. Create a repayment plan (Loan Page One)

3. Design a disbursement schedule (Loan Page One)

4. Establish interest rates, fees and debt service reserve accounts (Loan Page Two)

Hint: To switch between pages press the toggle button in the bottom left hand corner.

Caveat: You can always switch between the various capital expenditure categories (Site, Buildings, Equipment, Pre-Production or Manual Disbursement) while you make or once you have finished entries. However, if you change between categories, the program clears your repayment type and the selection (Equal Installments, Annuity or Manual Repayment Plan) because not all combinations are possible. It also clears your interest rate or basis points entries. So, if you switch, you have to select again the repayment type and reenter the interest rate or basis points (in case of a variable interest rate).

Financing—What Are Your Choices?

ProFinTools Project Finance gives you complete flexibility to finance any expenditure. You can either select a Capex category, an individual capex contract or even an expenditure sub category within a contract, let's say the import content. You can further decide on the share of contract payments that you want to finance (for example 50%). Moreover, by setting the disbursement schedule accordingly you can choose the time slice you want to finance for a contract or cost category. This can be useful if, for example, a down payment has to be made from the project company's funds in month 5 but the rest of the contract should be financed with a loan. Finally you can manually create your disbursement schedule.

Before you deal with financing issues, you should give some thought to repayment. This is necessary, because the repayment method chosen and the repayment schedule have repercussions on the disbursement schedule. For example you cannot disburse after the loan has been fully repaid. Three repayment methods available: Equal installments, annuity and manual repayment plan.

Equal Installments

You can use all interest rate types (fixed, variable and manual). Disbursements can be made during the repayment phase up to the Month of Last Repayment (see Loan Page One, bottom right corner). The interest can be capitalized up to and including the first repayment month. You can use the Sweep function to prepay the loan at payment dates if sufficient cash flow is available.

The program allows you to harmonize payment dates for interest and principal. In case of equal installments, ProFinTools Project Finance makes the first repayment date for principal also an interest payment date. If your principal is due every six months and you pay interest six months in arrears, interest and principal payment dates will coincide during the repayment phase. If the time between installments and the number of months interest is paid in arrears differ, interest and principal payment dates will not coincide.

Annuity

The interest rate must be fixed. Disbursements can be made until the last repayment installment (the program recalculates the annuity). Interest can be capitalized up to and including the first repayment month. You cannot use the Sweep function.

In case of an annuity, you can freely choose the number of months for interest to be paid in arrears during the disbursement phase. Starting with the first repayment, however, principal and interest payment dates coincide.

The debt service (interest+principal) should be equal in case of an annuity. There are two reasons why this might not be the case:

1. You have disbursed after the start of the repayment phase. The program recalculates the annuity. The debt service following this disbursement will be higher.

2. Interest and principal payment dates coincide during the repayment of an annuity. However, up to the first repayment date, it is up to you to set the interest payment schedule. If the last interest payment date is closer to the first repayment date than the interim period between repayment dates, the debt service at the first repayment date will be lower than the following (equal) debt services. This happens as part of the interest, otherwise due at the first repayment date, has already been paid.

Hint: If you switch from equal installments or a manual repayment plan to an annuity the program will override any interest entries. As you cannot combine an annuity with a variable interest rate or a manually designed interest time series, the interest type option buttons (fixed, variable and manual) will all disappear. The Interest p.a.−% entry box is set to zero. Make sure that you enter an interest rate for the annuity before you press Enter.

Manual Repayment Plan

The program allows you to tailor the repayment schedule. Disbursements can be made during the repayment phase up to the last repayment month. Interest can be capitalized up to the first repayment month. You can use all three interest rate types (fixed, variable and manual).

At any repayment date, you should not repay more than the loan utilization at this date. The program validates your entries accordingly and ensures that this does not happen. Example: The loan total is 1000 currency units. You repay in two installments. Assume you have entered 400 as the first installment. The validation will not allow you to enter more than 600 as the second installment. Now, if you return to the first installment and enter let's say 500, you will repay 1100 currency units—that is more than the company has borrowed. To avoid this the program checks your entries as you leave the form. If you have repaid too little, the program will add the amount still to be repaid to the last installment. If you have tried to repay more than a respective month's utilization your repayment will be restricted to the then outstanding amount. Therefore, you should always check in the loan output system what the model has done to your repayment plan.

Disbursement and Repayment Methods, Interest Rate Types—What Can I combine?

| Allowed combinations | | |
|---|---|---|
| Disbursement Method | Repayment Method | Interest Types |
| Automatic disbursement | Equal installments | Fixed Interest Rate |
| | | Variable Interest Rate |
| | | Manual Interest Rate |
| | Annuity | Fixed Interest Rate |
| Manual disbursement | Equal Installments | Fixed Interest Rate |
| | | Variable Interest Rate |
| | | Manual Interest Rate |
| | Annuity | Fixed Interest Rate |
| | Manual Repayment | Fixed Interest Rate |
| | | Variable Interest Rate |
| | | Manual Interest Rate |

While a manually created disbursement schedule can be combined with all three repayment-methods (equal installments, annuity or manual repayment plan), an automatic disbursement schedule is restricted to equal installments and annuities. Why? If the contract expenditure that you finance under an automatically created disbursement schedule changes (either because costs increases or the exchange rate changes) your loan disbursements will automatically vary with that change. This can be very handy and can save you a lot of retyping. However, if you have designed your repayments manually, the program cannot know how you want the new loan amount to be repaid.

However, you can create your manual disbursement schedule, using the automatic disbursement schedule to save a lot of typing even if you want to work with a manual repayment plan. Go through all the steps (described below) to create a loan with an automatic disbursement schedule. Once you have created the loan, call it up again, revisit Loan Page Two and select Manual in the Financing frame. If you access the disbursement schedule for editing you will find the entries that the program has created for the automatic disbursement schedule. However, there is one difference. Once you have re-entered the loan, disbursements will not change with variations in the underlying capex contract or variations in the exchange rate.

Start Repayment Phase

Regardless of the number of months that interest is paid in arrears, the month you enter as start of the repayment phase will be an interest payment date. In the case of an annuity, all later interest payment dates will coincide with the principal payment dates. In the cases of manual repayment or repayment in equal installments, the next interest payment date will be the number of months that interest is paid in arrears after this date. If you want interest and principal payment dates to always coincide, you should set the number of months interest is paid in arrears equal to the number of months between installments.

The Sweep Function

The Sweep uses free cash flow to prepay general-purpose loans at payment dates. If you want to use the Sweep, you have to press the Sweep button for each loan that should share in the Sweep. Available cash flow will be shared among the general-purpose loans participating in the Sweep according to their utilization (outstanding debt at this moment) taking into account funds accumulated for Sweep of this specific loan. This is done because payment dates do not necessarily coincide. Prepayment is made at interest payment dates until the repayment phase starts, from then on at principal payment dates. Ignoring amounts accumulated for the Sweep would put loans with later payment dates at an advantage in obtaining funds for prepayment.

The Sweep is held in units of the numéraire until used. You find a position in the balance sheet and in the cash flow. The sweep works with a time lag of at least one month. Funds cannot be used in the month they become available. This would cause circularity.

The Sweep can assume negative values. While cash flow set aside for the Sweep is kept in numéraire until used to prepay at payment dates, you can freely choose your loan currency. If the loan currency depreciates, funds set aside at earlier exchange rates might be bigger than what is needed to prepay the whole loan. The exceeding cash flow is released and will show up as a negative value in the cash flow.

Debt service reserve accounts are automatically adjusted to reflect the prepayments made with the Sweep.

The Sweep is available only with the equal installment repayment method.

Checklist: Enable the Sweep

1 Select Loans on the general and Stand-by Loans, Sweep on the drop-down menu.

2 Select the Month Start Sweep.

3 Select the Month of End Sweep.

4 Write the percentage of free cash flow to be used for the Sweep into the respective % Cash Flow box.

5 Press Enter.

6 Exit the form Stand-by Loans, Sweep.

7 On the general menu bar select Loans.

8 Select the loans that you want to participate in the Sweep one after the other.

9 Press the Sweep button on Loan Page One.

10 Press the Enter button.

Checklist: Look at or Publish the Sweep

1 Select Model on the ProFinTools Project Finance general menu bar.

2 Select Loans.

3 Choose the loan that you want to review and press either Publish or Show Me.

4 ProFinTools Project Finance shows you the principal loan data and graphs for utilization and debt service, the Sweep and the debt service reserve accounts.

Hint: If you make any changes that affect the cash flow during the Sweep period, the amount available for the Sweep will be affected.

General Loan Data—Loan Page Two

Loan Name

Write the name of the loan into the Loan name box.

Loan Currency

Select the Loan Currency (click, selected currency should turn blue). If you don't find the Loan Currency you want to use, press Enter in order not to lose entries made so far, exit Loans and select Global and then Currencies on the general menu bar.

Loan transactions are made in the loan currency. If the exchange rate changes, foreign exchange (forex) gains or losses result as more or less has to be repaid in units of the numéraire. ProFinTools Project Finance takes that into account.

Interest Types

ProFinTools Project Finance gives you three options:

Fixed Interest Rate

Variable Interest Rate

Manual Interest Rate

Select the option you want to use. However, there is one restriction: You cannot combine a variable interest rate or a manually designed interest rate time series with the annuity repayment method. While the interest type that you select applies to both the loan and the debt service reserve account the respective interest rates can differ.

Option Fixed Interest Rate

If you select the option Fixed Interest Rate, the graphical user interface shows you the Interest p.a.−% box . Write the interest rate per year into the Interest p.a.−% box. Example: if the interest rate is 5.5% write 5.5.

Option Variable Interest Rate

If you select the option Variable Interest Rate, you will see the entry box Basis points (+) or (−). Write the number of basis points you want to add or subtract from the project wide variable interest rate.

For example, if you want to add 1.4% (140 basis points) to the variable interest rate, write 140 into the Basis points (+) or (−) entry box.

If you want to subtract 0.9% (90 basis points), write −90 (minus 90) into the box.

Option Manual Interest Rate

If you select the Manual Interest Rate you will not see neither the Interest p.a.−% nor the Basis points (+) or (−) entry boxes. Instead the command button

Edit Loan Interest Rate and

Edit DSRA Interest Rate

pop up. Press the Edit Loan Interest Rate command button to gain access to the loan interest rate time series. The program presents you an entry form where you can enter an annual interest rate for every project month. This allows you to manually generate any conceivable interest rate pattern. Press Return once you are satisfied. (Do the same for the interest rate for the debt service reserve account).

Hint: If you switch between interest type options the interest rate or basis points entries will be cleared of the respective entry fields. The entry fields are set to zero or disappear (in case of manual interest rate). Therefore make sure to check these fields before you press Enter.

Interest Calculation Methods

Select the Interest Calculation Method (click, listbox has to turn blue). Two methods are available. With method Standard the year has 365 days. If you choose the Euro method the year has 360 days resulting in a higher de facto interest rate.

Number of Months Interest is Paid in Arrears

Select the number of months that interest is paid in arrears.

Percent of Interest Capitalized During the Disbursement Period

Write the percentage of interest to be capitalized into the % of Interest Capitalized entry box. If 50 percent is to be capitalized, write 50. The interest rate is necessary, but not sufficient, to ensure that interest is capitalized. You also have to determine the time period during which interest is to be capitalized. ProFinTools Project Finance allows you to capitalize interest up to and including the First Repayment Month. Before you can select the last month during which interest is to be capitalized the repayment schedule has to be established. This is done on Loan Page Two. See below how to establish a repayment schedule.

Management Fee

Write the percent of the total loan that has to be paid as management fee to the bank into the Management Fee % entry box. For example: if 1.5 percent has to be paid, write 1.5.

Arrangement Fee

Write the percent of the total loan that has to be paid as arrangement fee to the bank into the Arrangement Fee−% entry box. For example: if 0.75 percent has to be paid, write 0.75.

Commitment Fee

Write the percent of total loan that has to be paid as commitment fee to the bank into the Commitment Fee−% entry box. For example: if 0.25 percent has to be paid, write 0.25.

Debt Service Reserve Account (DSRA)

ProFinTools Project Finance allows you to establish debt service reserve accounts (DSRAs) for general-purpose loans. DSRAs are held in the loan currency. The program keeps track of the resulting currency gains and losses. Interest on outstanding amounts is paid in units of numéraire. Interest that cannot be paid when due for lack of funds is calculated, deferred and held in units of numéraire.

Interest on DSRA

Entries are subject to the interest type (Fixed Interest Rate, Variable Interest Rate or Manual Interest) that you have selected.

Option Fixed Interest Rate

Write the rate of interest payable per year on the utilization of the debt service reserve account into the Interest on DSRA−% box. If the interest rate is 5.5%, write 5.5.

Option Variable Interest Rate

If you select the option Variable Interest Rate, you will see the entry box Basis points (+) or (−). Write the number of basis points you want to add or subtract from the project wide variable interest rate.

Option Manual Interest Rate

Press the Edit DSRA Interest Rate command button to gain access to the debt service reserve account interest rate time series. Press Return once you are satisfied with the time series.

Interest in month t is paid on the utilization of the loan in month t−1 plus half the disbursement in month t (assumption: disbursement occurs in the middle of month t).

Base—Percent of Next Debt Service

ProFinTools Project Finance differentiates between the DSRA's during the disbursement and the repayment phases. Based on the next debt service, the program calculates the required amount to be held as a base in the DSRA. If the full next debt service (100 percent) is to be held as base, write 100 into the Disbursement Phase DSRA: DSRA as % of next Debt Service or Repayment Phase: DSRA as % of next Debt Service—entry box. If twice the next debt service is to be held as DSRA-base, write 200.

Monthly Step-ups

If you check the box Monthly Step-ups, the model calculates monthly step-ups to ensure that at payment dates for interest or principal, the corresponding step-up amounts are be paid in the DSRA on top of the required base. For example, if the next debt service amounts to 1000 currency units and base requirements are 100%, payments have to be made every 10th month, the model will require a base of 1000 and make 10 monthly step-ups of 100.

Note: If you capitalize interest up to the first repayment, the program will not generate step-ups for interest during the disbursement phase, as no interest is due.

Checklist: Establish What You Want to Finance

1 Select Loans on the general menu and Bank Loans on the drop down menu.

2 Select the Capex category in the frame Financing on Loan Page One.

Total CAPEX

Site

List of site contracts appears (click, selection should turn blue). Select either Total Site or one of the Site Contracts. If you don't find the contract you are looking for press Enter in order not to lose the entries made so far, exit form Loans, go to form CAPEX and enter the contract.

Buildings

List of building contracts appears (click, selection should turn blue). Select either Total Buildings or one of the Buildings Contracts. If you don't find the contract you are looking for, see instructions under Site above.

Equipment

List of equipment contracts appears (click, selection should turn blue). Select either Total Equipment or one of the Equipment Contracts. If you don't find the contract you are looking for, see instructions under Site above.

Pre-Production

List of pre-production contracts appears (click, selection should turn blue). Select either Total Pre-Production or one of the Pre-Production Contracts. If you don't find the contract you are looking for, see instructions under Site above.

Manual

Button—Edit Disbursment Schedule appears. The Enter button is blocked. Don't press the Edit Disbursement Schedule button now. Complete the following steps before you do so.

3 If you have not chosen Manual select an expenditure category:

Total Expenditure (this includes Customs)

Total Imports

Total Local Content

Imports and Customs

Local and Customs

Imports and Local Content

4 Write the percentage of the total expenditure or of the expenditure category you want to finance into the % of Payments financed box.

Checklist: Create a Repayment Plan

5 Go to the Repayment Frame on the right and select a repayment method (Equal Installments, Annuity or Manual Repayment Plan—click, selection should turn blue). Caveat: you cannot combine an annuity with either a variable or a manual interest rate.

6 Select the Month First Repayment.

7 Select the Number of Installments.

8 Select the number of months between installments. The model tells you when the last repayment will take place.

9 If you want to capitalize interest, select the Last Month Capitalization of Interest.

Checklist: Design a Disbursement Schedule

10 Go to the frame Disbursement Schedule (in the middle of Loan Page One).

11 Select the Month of Loan Effectiveness.

12 Select the First Disbursement Month.

13 Select the Last Disbursement Month.

Checklist: Establish Interest Rates, Fees and Debt Service Reserve Accounts

14 Switch to Loan Page Two. Select the interest type (fixed, variable or manual, Note, with an annuity you can only enter a fixed interest rate).

15 Enter basis points or write fixed interest rate. If you have selected Manual Interest Rate, press Edit Loan Interest Rate and Return, once you are done. Then press Edit DSRA Interest Rate and then also Return, once you are satisfied with the interest rates.

16 Write the management fee, arrangement fee and commitment fees, if any, in the respective entry fields.

17 Write the percentage of the next debt service that you want to keep during the disbursement and the repayment phase into the respective entry boxes.

18 If you have selected Equal Installments as repayment method, you are done. Press Enter.

Manual Disbursement and/or Repayment: A Special Case:

Checklist: Manual Disbursement and Annuity or Equal Installments

19 If you have selected the capital expenditure category Manual Disbursement and as repayment method Annuity or Equal Installments the Edit Disbursement Schedule button appears on Loan Page One. The buttons Enter Disbursement Schedule and Enter are disabled. Before you press the button Edit Disbursement Schedule perform all the steps above (Loan Page Two and enter interest, fees and debt service reserve accounts).

20 Then return to Loan Page One and press the button Edit Disbursement Schedule. The program shows you the manual disbursements entry form. Make your disbursement entries and press Return.

21 Press the Enter Disbursement Schedule button. The program runs for a while and then gives you access to the Enter button. Press this button and you are done.

Manual Disbursement and Manual Repayment

19 If you have selected Manual disbursement and Manual Repayment Plan, the model shows you on Loan Page One the button Edit Disbursement Schedule. The buttons Enter Disbursement Schedule and Enter are disabled.

20 Before you press the button Edit Disbursement Schedule go through all the steps above (Loan Page Two for the interest, fees and debt service reserve accounts entries.).

21 Then return to Loan Page One and press the button Edit Disbursement Schedule. The program shows you the manual disbursements entry form. Make your disbursement entries and press Return.

22 Press the Enter Disbursement Schedule button. The program runs for a while and then gives you access the button Edit Manual Repayment Schedule. Press this button. The program shows you an entry form for manual repayments. Fill out the repayments. Don't try to repay more than the loan utilization in the respective month. Press Return.

23 The Enter button is now enabled. Press Enter to write the repayment schedule into the case file. This will take some time, as the program has to do a lot of calculations to validate your repayment entries.

Checklist: Look at or Publish the Loan

1 Select Model on the general menu bar.

2 Select Loans.

3 Choose the loan that you want to review, then press either Publish or Show Me.

4 ProFinTools Project Finance shows you the principal loan data and graphs for utilization and repayment, the Sweep and the debt service reserve accounts.

Export Credit Insurance

If an exporter has to pay export credit insurance fees for a loan obtained by the project company to finance payments made to the exporter under a CAPEX contract, such fees should be included in the capital expenditure under the said contract (see chapter 5). This allows you to loan-finance the expenditure including the credit insurance fees.

Stand-By Loans

If the project-company does not generate sufficient funds to cover all its payment obligations, limited recourse can be made available through Stand-by Loans from project sponsors. Repayment will only take place if there is sufficient cash flow once other payments have been made. The above general purpose loans are senior to the Stand-by Loans. ProFinTools Project Finance pays interest on Stand-by Loans only if sufficient funds are available. Otherwise, interest payment is deferred.

Stand-by Loan Construction

Checklist: Establish a Stand-by Loan During the Construction Period

1 Select Loans on the general menu bar.

2 Click on Stand-by Loans, Sweep—the model loads the form.

3 Go to Stand-by Construction entry field and enter Maximum Stand by Amount in units of the numéraire.

4 Select the interest type (Fixed Interest Rate or Variable Interest Rate).

5 If you have selected Fixed Interest Rate, write the fixed interest rate into the Interest Rate−% p.a box. If you have selected variable interest rate, write the basis points you want to add or subtract into the Basis points (+) or (−).

6 Press Enter.

Stand-by Loan Repayment

Checklist: Establish a Stand-by Loan During the Repayment Period

1 Select Loans on the general menu bar.

2 Click on Stand-by Loans, Sweep—the program loads the stand-by entry form.

3 Go to Stand-by Loan Repayment Phase entry field and enter maximum loan amount in units of the numéraire.

4 Select the interest type (Fixed Interest Rate or Variable Interest Rate).

5 If you have selected Fixed Interest Rate, write the fixed interest rate into the Interest Rate−% p.a box. If you have selected variable interest rate, write the basis points you want to add or subtract into the Basis points (+) or (−).

6 Select the Last Disbursement Month.

7 Press Enter.

Hint: if you switch between interest types the program will set earlier interest rate or basis point entries in the graphical user interface to zero. For example: you switch from a fixed interest rate to a variable interest rate. The Interest Rate−% p.a. box is replaced by the Basis points (+) or (−) box with its value set to zero. Before you press Enter, make sure that the respective box shows the desired value.

Checklist: Look at or Publish Stand-by Loans

1 Select Model on the general menu bar.

2 Go to Financial Statements and select Monthly presentation.

3 Press either Publish to export or Show Me to look at the cash flow.

4 Press Return when done.

Alternative: Select Model and then Recourse.

Checklist: Delete a Stand-by Loan

1 Select Loans on the general menu bar.

2 Click on Stand-by Loans, Sweep—the program loads the stand-by entry form.

3 Click on the Delete button of either the Stand-by Loan Construction or Repayment Phase.

### CHAPTER 10

### ProFinTools Project Finance—Variable Costs

Variable Costs

This chapter focuses on variable costs like direct material costs or direct labor. Whenever you have an input-output coefficient, you should use variable costs. If your direct costs are fixed, enter such costs as fixed operating costs (see chapter 11). The chapter also deals with intermediate inputs that the project company produces itself but not in sufficient quantities to allow a desired output level. This can for example be the consequence of a maintenance shut down of an upstream production stage.

ProFinTools Project Finance foresees two different input-pricing mechanisms: (1) input prices determined by the prices in the input market and (2) input prices determined by sales (output market). The latter allows you to pass through some of the cash flow risks to your suppliers. In case you use the second pricing mechanism, you can also make use of a deferral (loan) mechanism.

Variable Costs Determined by Prices in the Input Market

To get access to the entry form select Variable Costs on the general menu and Costs determined by (Prices in the) Input Market on the drop-down menu. You can enter up to 14 inputs. Entries fall into two categories: technical and financial. Before you start with either of them, make sure you have filled in the form Name, Schedule and Technical Specs (general menu bar Global). You cannot enter any variable costs if you have not entered products first.

Select Product and Variable Cost Contract

Product

First select the end or intermediate product for which the input is needed. The program loads a list of the variable input needed for the production of this product into the variable cost box.

Variable Cost

Write/select the name of the cost or cost contract. This loads the data corresponding to these costs into the entry form.

Technical Entries

Unit of Measurement

Inputs are measured in their respective measurement units for example liters, gallons or tons.

Input-Output Coefficient

The program works with a linear production function that you define by telling the program how many units of the respective input factor are needed to produce one unit of output.

Minimum Stock

Write the number of units of the input factor held in stock into the Minimum Stock—No. of Units box. This number is needed to build inventories and working capital needs. ProFinTools Project Finance sets up automatically the minimum stock before the start-up of operations.

Days from Order to Delivery

Write the number of days from order to delivery into the Days from Order to Delivery box. You can enter any positive real number between 0 and 91.24. ProFinTools Project Finance needs this information to order the input on time.

Financial Entries

Variable Cost Currency

Select the contract currency in the listbox. The selected currency should turn blue. If you don't find the currency, press Enter to save entries made so far, exit Variable Costs determined by Prices in Input Market, on the general menu bar select Currencies. Once you have entered the currency, return to the form Variable Costs.

Price/Unit of Input Factor (in selected currency)

Write the Price per Unit of Input Factor into input factor cost box.

Input Unit Price Trend

If the unit price of the input factor increases, enter a positive number. For example, if the price per unit rises 10% per year, enter 10 in the Input Unit Price Trend−% p.a. box.

For price decreases, enter a negative number. For example: if the price per unit falls by 10% per year, enter −10 (minus 10).

First Month of Trend

Select the First Month of Trend. ProFinTools Project Finance allows you to start the trend at any project month lower than month 254. The default setting is 1 month.

Last Month of Trend

Select the Last Month of Trend. The program allows you to end the trend at any project month lower than month 254. The default setting is month two.

Percent of Price Swings—Volatility

Enter the percentage of up and down swings of the input factor price around the long-run price trend. This entry determines the amplitude of the price swings. For example, if you want the price of your input factor to go up by and down by 20% during a price cycle enter 20.

Months—Length of Cycle

A sine curve is used to simulate input price volatility. You can influence both the length of a price cycle and the amplitude of the price swings around the long-term price. The default length of cycle is 60 months.

Cycle Status at Project Start

Select one of the following options for your input factor price at project start (click, selection should turn blue):

Halfway up. (default)

Top Price.

Halfway down.

Bottom Price.

Percent Down Payment

Write the percentage of the down payment at time of order into the Down Payment−% entry box. For example, if the down payment is 15% write 15. This influences working capital needs.

Average Number of Days from Creation of Payment Obligation to Payment

Write the number of days from the creation of the payment obligation to the actual payment into the Average Days before Payment 0<Days<91 box. This can be any positive real number between 0 and 91.24. The program needs this information to calculate working capital needs.

Checklist: Enter an Input Factor

1 Select Variable Costs on the general menu bar. On the drop-down menu click on Costs determined by (Prices in) Input Market. The program loads the form.

2 Select the product.

3 Write/select the name of the input factor into the Variable Cost box.

4 Write the unit of measurement.

5 Write the input-output coefficient (number of units of input factor to produce one unit of output) into the Input-Output Coefficient box.

6 Write the number of units of the input factor to be held as iron stock into respective box or leave the default value.

7 Write the delivery time into the respective box or accept the default value zero.

8 Select the contract currency (click, selection should turn blue).

9 Write Price/Unit of Input Factor in the selected currency into the respective box.

Optional—In Case You Want to Establish a Price Trend or do Sensitivity Testing.

10 Write price trend per annum (p.a.) into the Input Unit Price Trend−% p.a. box.

11 Select the First Month of Trend and the Last Month of Trend.

12 Write the price volatility into the %−Price Swings box.

13 Select the cycle length.

14 Select the cycle status at project start—price half way up, Top Price, Half way down, Bottom Price (click, selection should turn blue).

15 Press Enter.

Checklist: Look at or Publish Variable Costs

1 Perform steps 1-15 above.

2 Exit Variable Costs.

3 Select Model on the general menu bar.

4 Press the button Cost of Goods, select the product and then the input cost factor you want to study or publish. The program shows you the input cost and an associated graph.

Checklist: Delete Variable Costs

1 Select product and then the variable cost input factor.

2 Press Delete.

Variable Costs Determined by Prices in Output Market (Sales Price)

You can enter two inputs of this type for each product. Entries fall in two categories: technical and financial. But first:

Select Product and Variable Cost Contract

Product

Select the product for which the input is needed. The program loads a list of variable inputs into the variable cost box.

Variable Costs

Write/select the name of the input factor or contract in the Contract Name Box. This resets the form.

Technical Entries (Skip This Section if You Have Read the Description of Technical Entries under Variable Costs Determined by Prices in Input Market and Go Directly to Financial Entries below).

Unit of Measurement

Inputs are measured in their respective units of measurement, for example, liters, gallons or tons.

Input-Output Coefficient

The program works with a linear production function that you define by telling the program how many units of the respective input factor are needed to produce one unit of output.

Minimum Stock

Write the number of units of the input factor held in stock into the Minimum Stock box. ProFinTools Project Finance needs to know this figure in order to calculate working capital needs. The program buys the permanent reserve before start-up of operations.

Days from Order to Delivery

Write the number of days it takes to receive the input factor from the time of order to receipt in stock into the Days from Order to Delivery box. This can be any positive real number between 0 and 91.24. The program needs this information to order the input factor on time.

Financial Entries

Base for Input Factor Pricing

You have two choices: (1) You can select an off-take (sales)—contract that will serve as a base for the input factor or (2) you can manually enter a market price scenario (for example, if you have a market study with price projections) that serves as your price base.

Case 1—Off-take Contract as Pricing Base

Select the off-take contract in the listbox (selection should turn blue). The Contract Currency box is disabled as you choose together with the off-take contract (that serves as a input price bases) the off-take contract's currency. If you don't find the off-take contract that you are looking for, press Enter to save your entries, unload the form and enter your off-take contract according to the procedure described in chapter 13. Return to the Variable Costs form and select first the variable cost contract and then the off-take Contract that should serve as a price base.

Case 2—Manual Entry

If you have a market study with long-term price projections select Manual Entry. Select the market price currency. Press Edit Market Prices. ProFinTools Project Finance shows you an entry field that allows you to enter for each project month an output market price. Press Return once you have completed your entries.

Alternatively, to minimize typing, you can first choose an off-take contract, enter it as a price base and in a second go edit it. This should be done, if an off-take contract is available, whose monthly prices have some resemblance with your intentions.

Input Price as Percent of Off-take—Contract or Manually Entered Sales Price Net of

VAT

Write the Cost/Unit as % of Sales Price paid by the buyer (Net of VAT, see chapter 13, page 67) in the respective box. For example, if the output sales price net of VAT is 100 currency units per unit of output and you want the price of the input/unit to be 50% of that price, write 50 into the entry box. The program prices the input factor always at 50% of the sales price net of VAT of your output—as long as the price is higher than a possibly stipulated minimum price.

Minimum Price/Unit Output

Long-term supply contracts often stipulate a minimum price. This minimum price usually increases through the project lifetime. Write this minimum price into the Minimum Price/Unit Box. Leave the default value 0 if no Minimum Price is agreed upon.

Minimum Price Increase p.a.

Write the minimum price increase per year into the %−Minimum Price Increase p.a. entry box. For example, if you want the minimum price to increase by 4.5% p.a., write 4.5. The yearly price increase is converted into monthly price increases.

First and Last Month of Minimum Price Increase

You can freely select the first and last month of the minimum price increase.

Percent Down Payment

Write the percentage of the down payment at time of order into the Down Payment−% entry box. For example, if the down payment is 15% write 15. This influences your working capital needs.

Average Days from Creation of Payment Obligation to Payment

Write the average number of days from the creation of the payment obligation for your input to the actual payment into the Average Days before Payment 0<Days<91 box. ProFinTools Project Finance needs this information to calculate working capital needs.

If you do not want to establish a payment credit mechanism, you are done. Press Enter.

Deferral of Payments due to Supplier—Payment Credit Mechanism

ProFinTools Project Finance allows you to shift part of the cash flow risks to the supplier. This is done through a deferral—credit mechanism. The company pays the full contract price but receives a loan from the off-taker equal to the deferred amount. The deferral credit mechanism is triggered when the following conditions are met:

The company cannot fulfill its payment obligations.

The input price is equal or higher than a negotiated trigger price.

The agreed deferral—credit is not yet fully utilized.

Maximum Deferral—Credit Amount

Write the Maximum Amount to be credited by the supplier into the Max Amount deferred box. Payments are credited in the contract currency. Repayment takes place only if sufficient funds are available. ProFinTools Project Finance takes care of foreign exchange gains or losses.

Trigger Input Price

Write the threshold price/unit of input at or above which the deferral—credit kicks in into the Trigger Price Deferral box. The trigger price must be entered in units of the contract currency.

Percentage Deferred

Write the percentage of payments to be deferred into the form of a deferral credit to the project company into the % deferred box. If a deferral credit amounting to 50 percent of the payments is to be provided, write 50.

Interest Rate per Year on Deferred Amount

If the project-company has to pay interest on the deferred amounts select either Fixed Interest Rate or Variable Interest Rate.

Fixed Interest Rate

If you have selected the option Fixed Interest Rate, write the interest rate per year into the Interest p.a. on Deferred Amount box. If the interest rate is 5.5%, write 5.5.

Variable Interest Rate

If you have selected the option Variable Interest Rate, write the number of basis points you want to add or subtract from the project wide variable interest rate into the Basis points (+) or (−) box.

Checklist: Enter an Input Factor

1 Select Variable Costs on the general menu.

2 Click on Variable Costs determined by Output Market. The program loads the entry form.

3 Select the product. If you have not yet entered your product, go to Global on the general menu bar and then to Name, Schedule and Technical Specs and make the necessary entries.

4 Write the name of the input factor into the Variable Cost box.

5 Write the unit of measurement.

6 Write the input-output coefficient (number of units of input factor necessary to produce one unit of output) into the Input-Output Coefficient box.

7 Write the number of units of the input factor to be held as iron stock into the respective box or leave the default value.

8 Write the delivery time into the respective box or accept the default value.

9 Select the off-take contract that will serve as a price base (click, selection should turn blue) or select manual entry. In case of manual entry select the contract currency.

10 Write the price of the input factor as percentage of the sales price per unit into the Cost/Unit as % of Sales Price entry box.

11 Write the Minimum Price/Unit into the respective entry box.

12 Write the increase per year of the minimum price into the respective box. Press Enter or continue with optional entries:

Checklist: Optional—If You Want to Establish a Deferral Credit

13 Write the maximum deferral—credit amount into the respective box (contract currency).

14 Write the Trigger Price Deferral into the entry box.

15 Write the percentage of the payments that are to be deferred into the % deferred box.

16 Select the interest rate type (fixed or variable).

17 If you have chosen a fixed interest rate, write the fixed interest rate into the % of Interest p.a. on deferred amount box. Else, in case of a variable interest rate, write the basis points you want to add or subtract from the project wide variable interest rate into the Basis points (+) or (−) box.

18 Press Enter—you are done.

Checklist: Look at or Publish Variable Costs

1 Perform Steps 1-18 above.

2 Exit Variable Costs.

3 Go to Model and then click on Show Me.

4 Select Costs of Goods.

5 Select the product and then the input you want to review or publish. Press Publish or Show Me. The program shows you the input costs and associated graphs.

Checklist: Delete Variable Costs

1 Select the product and then the variable cost input factor.

2 Press Delete.

The Intermediate Product Gap

ProFinTools Project Finance allows you (see form Name, Schedule and Technical Specs) to set for each project month and end- or intermediate product the percentage of potential capacity use. This outlines the project company's production possibility frontier. Whether the frontier is reached depends on two factors:

The technical design of your plant, specifically, the match between the output of a intermediate production stage and the input requirements of the following production stage.

The project company's decision to partly or completely sell the intermediate product or use it as input in the next production stage.

We call the lack of an intermediate product that causes the underutilization of a production stage an intermediate product gap. The intermediate product gap might be intended and you might simply want to accept the reduction of output. If the gap is not intended you can rectify the under usage through outside procurement, provided there is an economic way to procure the intermediate product.

Check Out the Intermediate Product Gap

There are two ways to find out whether you lack intermediate products:

Checklist: Look at or Publish the Intermediate Gap

1 On the main menu select Model and the drop down menu click on Show Me.

2 On the form Model click on Cost of Goods. A frame with two listboxes appears.

3 Click on the lower listbox. On the dropdown list you can select the intermediate gap or the output gap (output not produced for lack of the required intermediate product).

4 Click on Show Me.

Alternative Route:

3 After step 2 above select in the upper list box Product the end product or the intermediate product 2^{nd} stage—(the first stage per definition cannot suffer from an intermediate gap).

4 Click on the bottom listbox. On the drop down list select Capacity Use—Learning Curve and the press on Show Me. The program shows you the potential and actual output.

Close the Intermediate Gap

ProFinTools Project Finance allows you to buy the intermediate product that you lack. Procurement works like the procurement of any other variable cost input as discussed above in the section Variable Costs determined by Prices in the Input Market and you should refer to this section for details. However, the form Intermediate Product differs in some respects from the Variable Cost Determined by Prices in Input Market form.

Product

In the product combo box you find only the end product and the intermediate product (2^{nd} stage). The entry stage is not listed, as no intermediate products that otherwise would be produced in house are to be procured.

First select the end or intermediate product for which the input is needed. The program loads a list of the variable input needed for the production of this product into the variable cost box.

Variable Costs

If you select the end product in the product combo box, the label of the Variable Cost combo box displays Cost Intermediate Product (2^{nd} Stage). The Cost Intermediate Product (2^{nd} Stage) is the intermediate product that enters the final production stage. If you select the intermediate product (2^{nd} stage) in the product combo box, the label of the Variable Cost combo box displays Intermediate Product (Entry Stage). The output of the entry stage is used as input for the 2^{nd} stage.

Write the name of your intermediate product procurement contract into the entry box. You can use per intermediate product up to three contracts to close any possible intermediate gap.

Unit of Measurement and Input-Output Coefficient

No entries are required. The entry form displays the values that you have entered earlier on the form Name, Schedule and Technical Specs. (If you are unhappy with the values, go to Global on the general menu bar, click on the drop down menu on Name, Schedule and Technical Specs and fix the problem).

Minimum Stock—No of Input Units

Write the number of units of the intermediate product that you want to be held as permanent stock into the Minimum Stock—No of Input Units box.

Caveat: Entries add up. If you use three different contracts to procure the intermediate product and enter 100 units under contract one, 50 units under contract two and 30 units under contract three, you end up with a permanent stock of 180 units. The stock of intermediate inputs is farther influenced by the number of days the “finished” intermediate good remains in stock before it is either sold or used as input in the next production stage (see chapter 13).

Percent of Intermediate Input Gap

Write the percentage of the input gap that you want to close with the intermediate product procurement contract into the % of Intermediate Input Gap box. For example: if you want to close 10 percent of the gap, write 10.

Hint: The program buys the intermediate product only if there is a gap. The gap might be temporary, as, for example in case of a maintenance shut down of a production stage, or permanent, for example, if the entry stage has too little capacity installed to cater with its output for the needs of the second stage.

### SUPPLEMENTAL EXAMPLE I

The Widget Steel Mill

You want to create a steel mill. You have three production stages:

Entry Stage: Pellet plant for iron ore beneficiation.

Second Stage: Blast Furnace to produce pig iron.

Final Stage: Basic Oxygen Process to produce steel.

You have negotiated three turnkey contracts with three suppliers. The suppliers have subcontracted the construction work. The beneficiation plant is build by a Japanese contractor. Contract currency is the Yen. All site- and construction work is payable in USD.

The pellet plant uses iron ore as major input provided by a nearby mine under a long term supply contract with risk sharing. The blast furnace converts pellets into pig iron. In the final stage, the basic oxygen process, converts pig iron into steel.

The steel market is highly cyclical. The Widget Steel Mill is exposed to commodity price and foreign exchange risks. The banks want a limited recourse package that consists of

a stand-by loan for the construction phase;

a stand-by loan for the loan repayment phase;

a price formula for the iron ore (subject to a minimum price);

deferral of a part of the handling fee of the pig iron and steel off-take contracts if there is a cash flow crisis.

The banks tell you that that at least 30 percent of the required funds should be paid in as equity. They insist that the equity ratio must not go below 30% until start-up of operation. The banks don't want to finance any down payments.

You find the necessary entries below and in the case file steelmill.xls on the ProFinTools Project Finance CD. The case was calculated at constant prices. It is up to you to do the sensitivity testing.

It will take—depending on the speed of your computer—a couple of minutes to reconfigure ProFinTools Project Finance (go to File, Open and select steelmill.xls).

Questions:

1. How much commodity price volatility can the limited recourse package withstand before the widget steel mill defaults?

On the general menu go to Sales. On the drop-down menu click on Commodity Market Pricing.

Generate sales price increases/decreases or/and fluctuations (see chapter 13)

2. How much exchange rate volatility can the steel mill withstand?

On the general menu select Loans. On the drop-down menu click on Bank loans. Change the financing method to Manual (this prevents the loan amount to vary with the exchange rate—for details see chapter 6).

On the general menu go to Global. On the drop-down menu select Currencies.

Hit the company with a currency shock, a depreciation trend and/or cyclical exchange rate fluctuations (see chapter 4). E.g. try out a currency volatility of 50%, cycle length 60 months for the Peso (used for input coke).

3. The second stage does not produce sufficient pig iron for the basic oxygen process to work at full capacity. Close the input gap by buying pig iron from the outside.

Select Variable Costs on the general and Intermediate Product on the drop-down menu.

Select the end product Carbon Steel and enter a contract to close the input gap of pig iron (for details refer to Chapter 10).

Basic Project Data

| Project Name | Steel mill |
|---|---|
| Project Start Month | August |
| Project Start Year | 2001 |
| Start of Fiscal Year | January |
| Start-up of Operations - Project Month | 30 |
| End of Project - Project Month | 210 |

Production

| | Entry Stage | 2^{nd} Stage | End Product |
|---|---|---|---|
| Product Name | Pellets | Pig Iron | Carbon Steel |
| Measurement Unit of | Tons | Tons | Tons |
| Output | | | |
| Maximum Capacity p.a. | 6,000,000 | 4,500,000 | 6,500,000 |
| Type of Learning Curve | Linear | Flat | Flat |
| Actual Capacity Usage - % | 95% | 95% | 95% |
| Capacity Usage at Start- | 85% | 80% | 85% |
| up - % | | | |
| Learning Period - Months | 12 | 36 | 36 |
| Input-Output Coefficient | n/a | 2 | 0.6251 |
| Intermediate Product | Leave default 0 | Pellets | |
| Production Time/ | 6 min. | 4 | 45 min |
| Unit of Output | | | |
| Share in overheads | 40% | 30% | 30% |

Currencies

Numéraire

| | |
|---|---|
| Numeraire | USD |
| GDP Deflator - % | 0 |
| Last Project Month Inflation | n/a |

Additional Currencies

| Name | Peso | Yen | Euro | Pound |
|---|---|---|---|---|
| Exchange Rate | 5 | 105 | 2.1 | 0.95 |
| Exchg. Rate Trend | 0% | 0% | 0% | 0% |
| Last Month of | n/a | n/a | n/a | n/a |
| Exch. Rate Trend | | | | |
| Currency Swings | 0% | 0% | 0% | 0% |
| Length of Currency | n/a | n/a | n/a | n/a |
| Cycle | | | | |
| Start of Currency | n/a | n/a | n/a | n/a |
| Cycle | | | | |
| One Time | n/a | n/a | n/a | n/a |
| App./Depreciation | | | | |
| Month of One Time | n/a | n/a | n/a | n/a |
| App./Depreciation | | | | |

Capital Expenditure

Capex Site

| Contract | Site Acquisition | | Site Preparation | |
|---|---|---|---|---|
| Contract | USD | USD | USD | USD |
| Currency | | | | |
| Customs - % | 0% | | 0% | |
| Project Month | Import | Local | Import | Local |
| | Content | Content | Content | Content |
| 1 | | | | |
| 2 | | | | |
| 3 | | 500,000 | | |
| 4 | | | | |
| 5 | | | | |
| 6 | | | | 20,000 |
| 7 | | | | 30,000 |
| 8 | | | | 30,000 |
| 9 | | | | 20,000 |
| Total | | 500,000 | | 100,000 |

Capex Buildings

| | | | | | Basic Oxygen | |
|---|---|---|---|---|---|---|
| Contract | Pellet Plant | | Blast Furnace | | Process | |
| Contract | USD | USD | USD | USD | USD | USD |
| Currency | | | | | | |
| Customs - % | 0% | | 0% | | 0% | |
| Project Month | Import | Local | Import | Local | Import | Local |
| | Content | Content | Content | Content | Content | Content |
| 1 | | | | 3,000,000 | | |
| 2 | | 1,500,000 | | | | |
| 3 | | | | | | 3,750,000 |
| 4 | | | | | | |
| 5 | | | | | | |
| 6 | | | | 200,000 | | |
| 7 | | 100,000 | | 400,000 | | |
| 8 | | 200,000 | | 600,000 | | 100,000 |
| 9 | | 300,000 | | 1,000,000 | | 200,000 |
| 10 | | 500,000 | | 2,000,000 | | 500,000 |
| 11 | | 1,000,000 | | 2,200,000 | | 2,000,000 |
| 12 | | 1,100,000 | | 4,000,000 | | 4,000,000 |
| 13 | | 2,000,000 | | 1,000,000 | | 4,000,000 |
| 14 | | 2,000,000 | | 400,000 | | 5,000,000 |
| 15 | | 500,000 | | 200,000 | | 3,000,000 |
| 16 | | 200,000 | | | | 1,000,000 |
| 17 | | 100,000 | | | | 200,000 |
| 18 | | | | | | |
| 19 | | | | | | |
| 20 | | | | 1,000,000 | | |
| 21 | | 500,000 | | | | |
| 22 | | | | | | 1,250,000 |
| Total | | 10,000,000 | | 20,000,000 | | 25,000,000 |

Capex Equipment

| | | | | | Basic Oxygen | |
|---|---|---|---|---|---|---|
| Contract | Pellet Plant | | Blast Furnace Oven | | Process | |
| Contract | Yen | Yen | USD | USD | USD | USD |
| Currency | | | | | | |
| Customs - % | 5% | | 5% | | 5% | |
| Project Month | Import Content | Local | Import | Local | Import | Local |
| | | Content | Content | Content | Content | Content |
| 1 | 3,150,000,000 | | 27,000,000 | | 30,000,000 | 150,000 |
| 2 | | | | | | |
| 3 | | | | | | |
| 4 | | | | | | |
| 5 | | | | | | |
| 6 | | | | | | |
| 7 | | | | | | |
| 8 | | | | | | |
| 9 | | | | | | |
| 10 | | | | | | |
| 11 | | | | | | |
| 12 | | | | | | |
| 13 | | | | | | |
| 14 | | | | | | |
| 15 | | | 1,500,000 | | | |
| 16 | 30,000,000 | | 1,500,000 | | | |
| 17 | 40,000,000 | | 1,500,000 | | | |
| 18 | 70,000,000 | | 3,000,000 | | 2,000,000 | |
| 19 | 1,000,000,000 | | 6,000,000 | | 2,000,000 | |
| 20 | 4,000,000,000 | | 18,000,000 | | 2,500,000 | |
| 21 | 6,000,000,000 | | 30,000,000 | | 3,300,000 | |
| 22 | 4,500,000,000 | | 36,000,000 | | 6,600,000 | |
| 23 | 1,000,000,000 | | 24,000,000 | | 18,800,000 | 200,000 |
| 24 | 90,000,000 | | 12,000,000 | | 33,000,000 | 300,000 |
| 25 | 70,000,000 | | 6,000,000 | | 39,600,000 | 200,000 |
| 26 | | | 3,000,000 | | 26,400,000 | 100,000 |
| 27 | | | 1,500,000 | | 13,200,000 | |
| 28 | | | | | 6,600,000 | |
| 29 | | | | | 3,500,000 | |
| 30 | | | | | 2,550,000 | |
| 31 | | | | | | |
| 32 | | | | | | |
| 33 | | | | | | |
| 34 | | | | | | |
| 35 | | | | | | |
| 36 | | | | | | |
| 37 | | | | | | |
| 38 | | | | | | |
| 39 | | | | | | |
| 40 | | | | | 10,000,000 | 50,000 |
| 41 | | | | | | |
| 42 | 1,050,000,000 | | 9,000,000 | | | |
| Total | 21,000,000,000 | | 180,000,000 | | 200,000,000 | 1,000,000 |

Capex Pre-Production Costs

| Contract | Legal Fees | | Consulting | | Licenses | |
|---|---|---|---|---|---|---|
| Contract | USD | USD | Euro | Euro | Euro | Euro |
| Currency | | | | | | |
| Customs - % | 0% | | 0% | | 0% | |
| Project Month | Import | Local | Import | | Import | Local |
| | Content | Content | Content | Local Content | Content | Content |
| 1 | | 1,500,000 | 450,000 | | 750,000 | |
| 2 | | | 75,000 | | | |
| 3 | | | 75,000 | | | |
| 4 | | | 75,000 | | | |
| 5 | | | 75,000 | | | |
| 6 | | | 75,000 | | 4,250,000 | |
| 7 | | | 75,000 | | | |
| 8 | | | 75,000 | | | |
| 9 | | | 75,000 | | | |
| 10 | | | 75,000 | | | |
| 11 | | | 75,000 | | | |
| 12 | | | 75,000 | | | |
| 13 | | | 75,000 | | | |
| 14 | | | 75,000 | | | |
| 15 | | | 75,000 | | | |
| 16 | | | 75,000 | | | |
| 17 | | | 75,000 | | | |
| 18 | | | 75,000 | | | |
| 19 | | | 75,000 | | | |
| 20 | | | 75,000 | | | |
| 21 | | | 75,000 | | | |
| 22 | | | 75,000 | | | |
| 23 | | | 75,000 | | | |
| 24 | | | 75,000 | | | |
| 25 | | | 75,000 | | | |
| 26 | | | 75,000 | | | |
| 27 | | | 75,000 | | | |
| 28 | | | 75,000 | | | |
| 29 | | | 75,000 | | | |
| 30 | | | 75,000 | | | |
| 31 | | | | | | |
| 32 | | | | | | |
| 33 | | | | | | |
| 34 | | | | | | |
| 35 | | | | | | |
| 36 | | | | | | |
| 37 | | | | | | |
| 38 | | | | | | |
| 39 | | | | | | |
| 40 | | | 75,000 | | | |
| 41 | | | 75,000 | | | |
| 42 | | | 225,000 | | | |
| Total | | 1,500,000 | 3,000,000 | | 5,000,000 | |

Loans

Variable Interest Rate

| | |
|---|---|
| Interest Rate % p.a. (LIBOR) | 5.5 |
| Interest Trend (+) or (−) | 0 |
| Last Trend Month | n/a |
| Percent Volatility | 0 |
| Month Length of Cycle | n/a |
| Status at Project Start | Half-way up |
| One Time Interest Rate Shock | 0 |
| Month of One Time Shock | n/a |

Bank Loans

| Bank Loans | | | Basic Oxygen |
|---|---|---|---|
| Loan Name | Pellet Plant | Blast Furnace | Process |
| Loan Currency | Yen | USD | USD |

Interest

| | | | |
|---|---|---|---|
| Interest Type | Fixed Interest | Variable Interest | Variable |
| | Rate | Rate | Interest Rate |
| Basis Points | n/a | Libor + 100 | Libor + 150 |
| Interest p.a. - % | 5% | n/a | n/a |
| Interest Calc. Method | Standard | Standard | Standard |
| No. of Month Interest paid in | 6 | 6 | 6 |
| Arrears | | | |
| % of Interest Capitalized | 0% | 100% | 0% |

Fees

| | | | |
|---|---|---|---|
| Management Fee % | 1% | 1% | 1% |
| Arrangement Fee % | n/a | n/a | n/a |
| Commitment fee % | 0.25% | 0.25% | 0.25% |
| No. of Month Commitment Fee is | 3 | 3 | 3 |
| paid in Arrears | | | |

Debt Service Reserve Account

| | | | |
|---|---|---|---|
| Disbursement Phase DSRA - % | 100% | 100% | 100% |
| of next Debt Service | | | |
| Repayment Phase DSRA - % of | 100% | 100% | 100% |
| next Debt Service | | | |
| Interest Type DSRA | Fixed Interest | Variable Interest | Variable |
| | Rate | Rate | Interest Rate |
| Basis Points | n/a | Libor − 100 | Libor − 150 |
| Interest on DSRA - % p.a. | 4% | n/a | n/a |
| Monthly Step-ups | TRUE | TRUE | TRUE |

Financing

| | | | |
|---|---|---|---|
| Capex - Type/Manual | Equipment | Equipment | Equipment |
| Contract | Pellet Plant | Blast Furnace | Basic Oxygen |
| | | | Process |
| Category | Total | Total Expenditure | Total |
| | Expenditure | | Expenditure |
| % of Payments Financed | 100% | 100% | 100% |

Disbursement Schedule

| | | | |
|---|---|---|---|
| Month of Loan Effectiveness | 1 | 1 | 1 |
| First Disbursement Month | 16 | 15 | 18 |
| Last Disbursement Month | 42 | 42 | 40 |

Repayment

| | | | |
|---|---|---|---|
| Repayment Method | Equal | Equal Installments | Equal |
| | Installments | | Installments |
| Sweep | FALSE | FALSE | FALSE |
| Last Month Capit. of Interest | N/a | 30 | n/a |
| Month - Start Repayment Phase | 30 | 30 | 30 |
| First Repayment Month | 36 | 36 | 36 |
| No. of Installments | 10 | 10 | 10 |

Stand-by Loans

| Stand-by Loan Construction Phase | USD |
|---|---|
| Maximum Amount | 10,000,000 |
| Interest Type | Variable Interest Rate |
| Basis points | Libor - 100 |
| % Interest p.a. | n/a |
| Stand-by Loan Repayment Phase | USD |
| Maximum Amount | 9,000,000 |
| Last Disbursement Month Stand-by Repayment | 96 |
| Phase | |
| Interest Type | Variable Interest Rate |
| Basis points | Libor - 100 |
| % Interest p.a. | n/a |

Sweep

| | |
|---|---|
| % of Cash Flow | 0% |
| Month - Start Sweep | n/a |
| Month - End Sweep | n/a |

Paid in Capital—Equity

| Project Month | Capital Paid in this Month - USD |
|---|---|
| 1 | 100,000,000 |
| 2 | |
| 3 | 9,080,000 |
| 4 | |
| 5 | |
| 6 | |
| 7 | |
| 8 | |
| 9 | |
| 10 | 1,900,000 |
| 11 | 5,250,000 |
| 12 | 9,470,000 |
| 13 | 10,050,000 |
| 14 | 8,500,000 |
| 15 | 4,700,000 |
| 16 | 1,900,000 |
| 17 | 800,000 |
| 18 | 2,000,000 |
| 19 | 4,400,000 |
| 20 | 15,000,000 |
| 21 | 21,800,000 |
| 22 | 21,000,000 |
| 23 | 12,300,000 |
| 24 | 17,500,000 |
| 25 | 12,600,000 |
| 26 | 8,500,000 |
| 27 | 5,100,000 |
| 28 | 3,160,000 |
| 29 | 4,500,000 |
| 30 | 57000,000 |
| Total | 336,510,000 |

Dividends

| | |
|---|---|
| % - Dividend | 100% |
| Payments | Quarterly |
| First Dividend Month | 42 |
| Minimize Additional Shareholder Investment | False |

Subsidies

| Manual Entry of Subsidies | n/a |
|---|---|
| Automatic Entry of Subsidies | n/a |
| Start Subsidy - Month | n/a |
| Last Subsidy - Month | n/a |
| Subsidy p.a. | 0 |

Taxes

Corporate Tax

| Manual Tax Rate Entry | FALSE |
|---|---|
| Automatic Tax Rate Entry | TRUE |
| % - Tax Rate retained Income | 20% |
| % - Tax Rate disbursed income | 30% |
| Tax Payment | Quarterly |
| Tax Holiday - Until Project Month | 42 |
| % - Tax Rate retained Income during | 10% |
| Holiday | |
| % - Tax Rate Disb. Income during | 20% |
| Holiday | |
| Years - Carry forward Losses | 5 |

Property Tax

| | |
|---|---|
| Manual Tax Rate Entry | n/a |
| Automatic Tax Rate Entry | n/a |
| % - Property Tax Rate | 0% |
| Tax Payment | n/a |
| Tax Holiday - Until Project Month | n/a |
| % - Tax Rate during Holiday | n/a |

Depreciation

| | | | | Interest |
|---|---|---|---|---|
| | | | Pre-Prod. | During |
| Capex Category | Buildings | Equipment | Exp. | Constr. |
| Reinvestment | TRUE | TRUE | FALSE | FALSE |
| Linear Depreciation - Years | 20 | 8 | 5 | 5 |
| Reinvestment % of Capex | 0.50% | 2% | n/a | n/a |
| First Reinvestment - Years | 6 | 4 | n/a | n/a |
| after Start-up | | | | |
| Last Reinvestment - Years | 15 | 15 | n/a | n/a |
| after Start-up | | | | |
| No. of Months between | 36 | 24 | n/a | n/a |
| Reinvestments | | | | |

Overheads

Maintenance

| Maintenance Category | Site | Buildings | Equipment |
|---|---|---|---|
| Method - % of Capex | TRUE | TRUE | TRUE |
| Method - Manual | FALSE | FALSE | FALSE |
| % of Capex | 0.50% | 1% | 2.50% |
| Manual - Numeraire | n/a | n/a | n/a |
| Increase - % p.a. | 0% | 0% | 0.50% |
| First Month Maintenance Inc. | n/a | n/a | 120 |
| Last Month Maintenance Inc. | n/a | n/a | 210 |

Administration Factory Overheads and Insurance

| | Administrative | Factory | |
|---|---|---|---|
| | Costs | Overheads | Insurance |
| Currency | USD | USD | USD |
| Cost p.a. at Prices Current at | 2,000,000 | 6,000,000 | 4,000,000 |
| Project Start | | | |
| Cost Increase p.a. - % | 0% | 0% | 0% |
| First Month Cost Increase | n/a | n/a | n/a |
| Last Month Cost Increase | n/a | n/a | n/a |

Fixed Operating Costs

Entry Stage: Pellet Plant—Intermediate Product—Pellets

| | | | | | |
|---|---|---|---|---|---|
| | | Cost p.a. | | First | Last |
| Fixed Operating | | Project | Cost Inc. | Month | Month |
| Cost | Currency | Start | p.a. - % | Increase | Increase |

Three shifts

| | | | | | |
|---|---|---|---|---|---|
| Supervisors | USD | 180,000 | 0% | n/a | n/a |
| First Operators | USD | 140,000 | 0% | n/a | n/a |
| Operators | USD | 360,000 | 0% | n/a | n/a |
| Laboratory | USD | 130,000 | 0% | n/a | n/a |

Only Daytime

| | | | | | |
|---|---|---|---|---|---|
| Chief Engineer | USD | 70,000 | 0% | n/a | n/a |
| Process engineer | USD | 60,000 | 0% | n/a | n/a |
| Lab Technicians | USD | 110,000 | 0% | n/a | n/a |
| Plumbers | USD | 90,000 | 0% | n/a | n/a |
| Electricians | USD | 90,000 | 0% | n/a | n/a |

Second Stage: Blast Furnace Oven—Intermediate Product: Pig Iron

| | | | | | |
|---|---|---|---|---|---|
| | | Cost p.a. | | First | Last |
| Fixed Operating | | Project | Cost Inc. | Month | Month |
| Cost | Currency | Start | p.a. - % | Increase | Increase |

Three shifts

| | | | | | |
|---|---|---|---|---|---|
| Supervisors | USD | 120,000 | 0% | n/a | n/a |
| First Operators | USD | 72,000 | 0% | n/a | n/a |
| Operators | USD | 340,000 | 0% | n/a | n/a |
| Laboratory | USD | 24,000 | 0% | n/a | n/a |

Only Daytime

| | | | | | |
|---|---|---|---|---|---|
| Chief of plant | USD | 70,000 | 0% | n/a | n/a |
| Process engineer | USD | 60,000 | 0% | n/a | n/a |
| Lab Technicians | USD | 72,000 | 0% | n/a | n/a |
| Computer Exp. | USD | 40,000 | 0% | n/a | n/a |
| Electrician | USD | 30,000 | 0% | n/a | n/a |
| Plant Safety | USD | 24,000 | 0% | n/a | n/a |

Final Stage: Basic Oxygen Process—End Product—Carbon Steel

| | | | | | |
|---|---|---|---|---|---|
| | | Cost p.a. | | First | Last |
| Fixed Operating | | Project | Cost Inc. | Month | Month |
| Cost | Currency | Start | p.a. - % | Increase | Increase |

Three shifts

| | | | | | |
|---|---|---|---|---|---|
| Supervisors | USD | 96,000 | 0% | n/a | n/a |
| First Operators | USD | 72,000 | 0% | n/a | n/a |
| Operators | USD | 228,000 | 0% | n/a | n/a |
| Laboratory | USD | 48,000 | 0% | n/a | n/a |

Only Daytime

| | | | | | |
|---|---|---|---|---|---|
| Chief of Plant | USD | 75,000 | 0% | n/a | n/a |
| Process Engineer | USD | 65,000 | 0% | n/a | n/a |
| Lab Technicians | USD | 72,000 | 0% | n/a | n/a |
| Plumbers | USD | 60,000 | 0% | n/a | n/a |
| Electrician | USD | 30,000 | 0% | n/a | n/a |
| Plant Safety | USD | 24,000 | 0% | n/a | n/a |

Variable Costs

Entry Stage: Pellet Plant—Intermediate Product—Pellets

| Name | Electricity | Water | Lubricant |
|---|---|---|---|
| Unit of Measurement | Kwh | cbm | Tons |
| Input-Output Coeff. | 100 | 100 | 0.05 |
| Minimum Stock | 0 | 0 | 100 |
| Delivery Time | 0 | 0 | 30 |
| Currency | USD | USD | Euro |
| Price/Unit of Input | 0.15 | 0.05 | 5 |
| Input Price Trend p.a. | 0% | 0% | 0% |
| First Month Trend | n/a | n/a | n/a |
| Last Month Trend | n/a | n/a | n/a |
| % Price Swings | 0% | 0% | 0% |
| Months Length of Cycle | n/a | n/a | n/a |
| Cycle at Project Start | n/a | n/a | n/a |
| Down Payment | 0 | 0 | 15% |
| Avg. Days before Paym. | 60 | 0 | 40 |

Entry Stage: Pellet Plant—Intermediate Product—Pellets

| Name | Iron Ore |
|---|---|
| Unit of Measurement | Tons |
| Input-Output Coeff. | 2 |
| Minimum Stock | 3,000 |
| Delivery Time | 1 |
| Trigger Price Deferral - USD | 40 |
| % deferred | 50% |
| Max. Amount deferred | 2,000,000 |
| % Interest p.a. on deferred Amount | 3% |
| Sales Contract | Pellet Sales |
| Currency | USD |
| Cost/Unit as % of Sales Price | 40% |
| Minimum Price/Unit Input (USD) | 15 |
| %-Minimum Price increase p.a. | 0% |
| First Month Trend | n/a |
| Last Month Trend | n/a |
| Down Payment | 15 |
| Avg. Days before Paym. | 40 |

Second Stage: Blast Furnace—Intermediate Product—Pig Iron

| | | Lime | Scrap | Process |
|---|---|---|---|---|
| Name | Coking Coal | Stone | and Misc. | Water |
| Unit of | Tons | Tons | Tons | Cbm |
| Measurement | | | | |
| Input-Output | 1.0952 | 0.317 | 0.1428 | 100 |
| Coefficient | | | | |
| Minimum Stock | 1,000,000 | 1,000 | 500 | 1000 |
| Delivery Time | 50 | 50 | 20 | 0 |
| Currency | Peso | USD | USD | USD |
| Price/Unit of | 1,000 | 20 | 30 | 0.06 |
| Input | | | | |
| Input Price | 0% | 0% | 0% | 0% |
| Trend p.a. | | | | |
| First Month | n/a | n/a | n/a | n/a |
| Trend | | | | |
| Last Month | n/a | n/a | n/a | n/a |
| Trend | | | | |
| % Price Swings | n/a | 0 | 0 | 0 |
| Months Length | n/a | n/a | n/a | n/a |
| of Cycle | | | | |
| Cycle at Project | n/a | n/a | n/a | n/a |
| Start | | | | |
| Down Payment | 15% | 15% | 15% | 15 |
| Avg. Days | 50 | 50 | 40 | 50 |
| before Paym. | | | | |

Final Stage: Basic Oxygen Process—End Product—Carbon Steel

| | Alloying | | Lime | Scrap | |
|---|---|---|---|---|---|
| Name | Elements | Iron Ore | Stone | Metal | Process Water |
| Unit of | Tons | Tons | Tons | Tons | cbm |
| Measurement | | | | | |
| Input-Output | 0.02 | 0.08 | 0.05 | 0.47 | 50 |
| Coefficient | | | | | |
| Minimum Stock | 20 | 1000 | 500 | 1000 | 0 |
| Delivery Time | 30 | 1 | 40 | 40 | 0 |
| Currency | USD | USD | USD | USD | USD |
| Price/Unit of | 150 | 20 | 20 | 12 | 0.05 |
| Input | | | | | |
| Input Price | 0% | 0% | 0% | 0% | 0% |
| Trend p.a. | | | | | |
| First Month | n/a | n/a | n/a | n/a | n/a |
| Trend | | | | | |
| Last Month | n/a | n/a | n/a | n/a | n/a |
| Trend | | | | | |
| % Price Swings | n/a | 0 | 0 | 0 | 0 |
| Months Length | n/a | n/a | n/a | n/a | n/a |
| of Cycle | | | | | |
| Cycle at Project | n/a | n/a | n/a | n/a | n/a |
| Start | | | | | |
| Down Payment | 15 | 15 | 15 | 15 | 0 |
| Avg. Days | 20 | 60 | 40 | 40 | 0 |
| before Paym. | | | | | |

Intermediate Product Availability as Input

| | Availability as Input for next production |
|---|---|
| Intermediate Product | Stage |
| Entry Stage - Pellets | 100% |
| Second Stage - Pig Iron | 100% |

Sales—Off-take Contracts

Entry Stage—Intermediate Product—Pellets

| Off-take Contract Data | |
|---|---|
| Product | Pellets |
| Contract | Pellet Sales |
| Contract Currency | USD |
| Share of Contract | 100% |
| Avg. No. Days before | 30 |
| Receipt of Payment | |
| Automatic Price | TRUE |
| Price per Unit | 50 |
| Sales Price Trend p.a. | 0% |
| First Month Trend | n/a |
| Last Month Trend | n/a |
| % Price Swings | 0% |
| Months - Length of Cycle | n/a |
| Cycle at Project Start | n/a |
| Sales Expenses Company | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Sales Expenses Off-Taker | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Fees | |
| Handling Fee - % | 5% |
| Flat Fee p.a. | 0 |
| % Flat Fee Increase p.a. | 0% |
| First Month Flat Fee | n/a |
| Increase | |
| Last Month Flat Fee | n/a |
| Increase | |
| Taxes and Duty | |
| Indirect Tax - % | 0% |
| Duty | 0% |
| % Handling Fee deferred | 50% |
| % Flat fee deferred | 50% |
| Trigger Price | USD 25 |
| Max. amount deferred | USD 2,000,000 |
| % Interest on deferred | 3% |
| Amount | |

Second Stage—Intermediate Product—Pig Iron

| Off-take Contract Data | |
|---|---|
| Product | Pig Iron |
| Contract | Pig Iron Sales |
| Contract Currency | USD |
| Share of Contract | 100% |
| Avg. No. Days before | 30 |
| Receipt of Payment | |
| Automatic Price | TRUE |
| Price per Unit | 200 |
| Sales Price Trend p.a. | 0% |
| First Month Trend | n/a |
| Last Month Trend | n/a |
| % Price Swings | 0% |
| Months - Length of Cycle | n/a |
| Cycle at Project Start | n/a |
| Sales Expenses Company | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Sales Expenses Off-Taker | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Fees | |
| Handling Fee - % | 5% |
| Flat Fee p.a. | 0 |
| % Flat Fee Increase p.a. | n/a |
| First Month Flat Fee | n/a |
| Increase | |
| Last Month Flat Fee | n/a |
| Increase | |
| Taxes and Duty | |
| Indirect Tax - % | 0% |
| Duty | 0% |
| % Handling Fee deferred | 50% |
| % Flat fee deferred | 50% |
| Trigger Price | USD 150 |
| Max. amount deferred | USD 2,000,000 |
| % Interest on deferred | 3% |
| Amount | |

Final Stage: Basic Oxygen Process—End Product—Carbon Steel

| Off-take Contract Data | |
|---|---|
| Product | Carbon Steel |
| Contract | Steel Sales |
| Contract Currency | USD |
| Share of Contract | 100% |
| Avg. No. Days before | 30 |
| Receipt of Payment | |
| Automatic Price | TRUE |
| Price per Unit | 450 |
| Sales Price Trend p.a. | 0% |
| First Month Trend | n/a |
| Last Month Trend | n/a |
| % Price Swings | 0% |
| Months - Length of Cycle | n/a |
| Cycle at Project Start | n/a |
| Sales Expenses Company | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Sales Expenses Off-Taker | |
| Currency Transport Cost | USD |
| Transport Cost/Unit | 30 |
| % Cost Increase p.a. | 0% |
| First Month Transport Cost | n/a |
| Increase | |
| Last Month Transport Cost | n/a |
| Increase | |
| Currency Insurance | USD |
| Insurance Cost/Unit | 1 |
| % Cost Increase p.a. | 0% |
| First Month Insurance Cost | n/a |
| Increase | |
| Last Month Insurance Cost | n/a |
| Increase | |
| Fees | |
| Handling Fee - % | 5% |
| Flat Fee p.a. | 30,000 |
| % Flat Fee Increase p.a. | 0% |
| First Month Flat Fee | N/a |
| Increase | |
| Last Month Flat Fee | N/a |
| Increase | |
| Taxes and Duty | |
| Indirect Tax - % | 0% |
| Duty | 0% |
| Deferral | |
| % Handling Fee deferred | 50% |
| % Flat fee deferred | 50% |
| Trigger Price | USD 400 |
| Max. Amount deferred | USD 2,000,000 |
| % Interest on deferred | 3% |
| Amount | |

### SUPPLEMENTAL EXAMPLE II

The Widget Cracker

You are a US based entrepreneur. You want to build a distillation plant. One barrel of crude oil gives you

| | |
|---|---|
| 0.6 barrels of gasoline | main product, |
| 0.3 barrels of diesel | joint product 1 |
| 0.1 barrels of bitumen. | Joint product 2. |

Per unit of main product you receive 0.5 units of joint product one and 0.166666 units of joint product two.

You have negotiated a turnkey contract with an European supplier. Contract currency is the Euro. The supplier has subcontracted the construction work to a US contractor. All site- and construction work is payable in USD.

The cracker uses crude oil as major input provided under a long term contract with a local supplier from Texas.

Your diesel and bitumen output is sold domestically, as is half of the gasoline. The remaining gasoline is shipped to a Latin American country and paid in Pesos.

The oil market is highly cyclical. The Widget Cracker is exposed to commodity price and foreign exchange risks. The banks want a limited recourse package that consists of

a stand-by loan for the construction phase;

a stand-by loan for the loan repayment phase;

a price formula for the local crude oil supply contract (subject to a minimum price);

deferral of a part of the handling fee of the output off-take contracts if there is a cash flow crisis.

The banks tell you that that at least 30 percent of the required funds should be paid in as equity. They insist that the equity ratio must not go below 30% until start-up of operation. The banks don't want to finance any down payments.

You find the necessary entries below and in the case file cracker.xls on the ProFinTools Project Finance CD. The case was calculated at constant prices. It is up to you to do the sensitivity testing.

It will take—depending on the speed of your computer—a couple of minutes to reconfigure ProFinTools Project Finance (go to File, Open and select cracker.xls).

Questions:

1. How much commodity price volatility can the limited recourse package withstand before the widget cracker defaults?

On the general menu go to Sales. On the drop-down menu click on Commodity Market Pricing.

Generate sales price increases/decreases or/and fluctuations (see chapter 13)

2. How much exchange rate volatility can the project withstand?

On the general menu select Loans. On the drop-down menu click on Bank loans. Change the financing method to Manual (this prevents the loan amount to vary with the exchange rate—for details see chapter 6).

On the general menu go to Global. On the drop-down menu select Currencies.

Hit the company with a currency shock, a depreciation trend and/or cyclical exchange rate fluctuations (see chapter 4).

Basic Project Data

| Project Name | Cracker |
|---|---|
| Project Start Month | August |
| Project Start Year | 2001 |
| Start of Fiscal Year | January |
| Start-up of Operations - Project Month | 30 |
| End of Project - Project Month | 210 |

Production

| Product Name | Gasoline | Diesel | Bitumen |
|---|---|---|---|
| Measurement Unit of Output | Barrel | barrel | Barrel |
| Maximum Capacity p.a. | 1,200,000,000 | n/a | n/a |
| Type of Learning Curve | Linear | n/a | n/a |
| Actual Capacity Usage - % | 95% | n/a | n/a |
| Capacity Usage at Start-up - % | 50% | n/a | n/a |
| Learning Period - Months | 12 | n/a | n/a |
| Units Joint Product per Unit of | n/a | 0.5 | 0.166666 |
| Main Product | | | |
| Production Time/Unit of Output | 3 hours | n/a | n/a |
| Share in production costs | n/a residual | 30% | 10% |

Currencies

Numéraire

| | |
|---|---|
| Numeraire | USD |
| GDP Deflator - % | 0 |
| Last Project Month Inflation | n/a |

Additional Currencies

| Name | Euro | Pesos |
|---|---|---|
| Exchange Rate | 1.3 | 10 |
| Exchg. Rate Trend | 0%. | 0%. |
| Last Month of | n/a | n/a |
| Exch. Rate Trend | | |
| Currency Swings | 0% | 0% |
| Length of Currency | n/a | n/a |
| Cycle | | |
| Start of Currency | n/a | n/a |
| Cycle | | |
| One Time | n/a | n/a |
| App./Depreciation | | |
| Month of One Time | n/a | n/a |
| App./Depreciation | | |

Capital Expenditure

Capex Site

Contract

| | |
|---|---|
| Site Acquisition | Site Preparation |

Contract Currency

| | | | |
|---|---|---|---|
| USD | USD | USD | USD |

Customs-%

| | 0% | | 0% | |
|---|---|---|---|---|
| Project | Import | Local | Import | Local |
| Month | Content | Content | Content | Content |
| 1 | | | | |
| 2 | | | | |
| 3 | | 500,000 | | |
| 4 | | | | |
| 5 | | | | |
| 6 | | | | 20,000 |
| 7 | | | | 30,000 |
| 8 | | | | 30,000 |
| 9 | | | | 20,000 |
| Total | | 500,000 | | 100,000 |

Capex Buildings

| Contract | | |
|---|---|---|
| | Distillation Buildings | |
| Contract Currency | USD | USD |
| Customs - % | | 0% |
| Project Month | Import | Local |
| | Content | Content |
| 1 | | |
| 2 | | 1,500,000 |
| 3 | | |
| 4 | | |
| 5 | | |
| 6 | | |
| 7 | | 100,000 |
| 8 | | 200,000 |
| 9 | | 300,000 |
| 10 | | 500,000 |
| 11 | | 1,000,000 |
| 12 | | 1,100,000 |
| 13 | | 2,000,000 |
| 14 | | 2,000,000 |
| 15 | | 500,000 |
| 16 | | 200,000 |
| 17 | | 100,000 |
| 18 | | |
| 19 | | |
| 20 | | |
| 21 | | 500,000 |
| 22 | | |
| Total | | 10,000,000 |

Capex Equipment

| Contract | Distillation Plant | |
|---|---|---|
| Contract | Euro | Euro |
| Currency | | |
| Customs - % | 5% | |
| | | Local |
| Project Month | Import Content | Content |
| 1 | 30,000,000 | |
| 2 | | |
| 3 | | |
| 4 | | |
| 5 | | |
| 6 | | |
| 7 | | |
| 8 | | |
| 9 | | |
| 10 | | |
| 11 | | |
| 12 | | |
| 13 | | |
| 14 | | |
| 15 | | |
| 16 | 5,000,000 | |
| 17 | 10,000,000 | |
| 18 | 10,000,000 | |
| 19 | 10,000,000 | |
| 20 | 25,000,000 | |
| 21 | 25,000,000 | |
| 22 | 20,000,000 | |
| 23 | 10,000,000 | |
| 24 | 10,000,000 | |
| 25 | 10,000,000 | |
| 26 | 10,000,000 | |
| 27 | 5,000,000 | |
| 28 | 5,000,000 | |
| 29 | 5,000,000 | |
| 30 | | |
| 31 | | |
| 32 | | |
| 33 | | |
| 34 | | |
| 35 | | |
| 36 | | |
| 37 | | |
| 38 | | |
| 39 | | |
| 40 | | |
| 41 | | |
| 42 | 10,000,000 | |
| Total | 200,000,000 | |

Capex Pre-Production Costs

| Contract | Legal Fees | | Consulting | | Licenses | |
|---|---|---|---|---|---|---|
| Contract | USD | USD | Euro | Euro | Euro | Euro |
| Currency | | | | | | |
| Customs - % | 0% | | 0% | | 0% | |
| Project Month | Import | Local | Import | | Import | Local |
| | Content | Content | Content | Local Content | Content | Content |
| 1 | | 1,500,000 | 450,000 | | 750,000 | |
| 2 | | | 75,000 | | | |
| 3 | | | 75,000 | | | |
| 4 | | | 75,000 | | | |
| 5 | | | 75,000 | | | |
| 6 | | | 75,000 | | 4,250,000 | |
| 7 | | | 75,000 | | | |
| 8 | | | 75,000 | | | |
| 9 | | | 75,000 | | | |
| 10 | | | 75,000 | | | |
| 11 | | | 75,000 | | | |
| 12 | | | 75,000 | | | |
| 13 | | | 75,000 | | | |
| 14 | | | 75,000 | | | |
| 15 | | | 75,000 | | | |
| 16 | | | 75,000 | | | |
| 17 | | | 75,000 | | | |
| 18 | | | 75,000 | | | |
| 19 | | | 75,000 | | | |
| 20 | | | 75,000 | | | |
| 21 | | | 75,000 | | | |
| 22 | | | 75,000 | | | |
| 23 | | | 75,000 | | | |
| 24 | | | 75,000 | | | |
| 25 | | | 75,000 | | | |
| 26 | | | 75,000 | | | |
| 27 | | | 75,000 | | | |
| 28 | | | 75,000 | | | |
| 29 | | | 75,000 | | | |
| 30 | | | 75,000 | | | |
| 31 | | | | | | |
| 32 | | | | | | |
| 33 | | | | | | |
| 34 | | | | | | |
| 35 | | | | | | |
| 36 | | | | | | |
| 37 | | | | | | |
| 38 | | | | | | |
| 39 | | | | | | |
| 40 | | | 75,000 | | | |
| 41 | | | 75,000 | | | |
| 42 | | | 225,000 | | | |
| Total | | 1,500,000 | 3,000,000 | | 5,000,000 | |

Loans

Variable Interest Rate

| | |
|---|---|
| Interest Rate % p.a. (LIBOR) | 5.5 |
| Interest Trend (+) or (−) | 0 |
| Last Trend Month | n/a |
| Percent Volatility | 0 |
| Month Length of Cycle | n/a |
| Status at Project Start | Half-way up |
| One Time Interest Rate Shock | 0 |
| Month of One Time Shock | n/a |

Bank Loans

| Loan Name | Distillation |
|---|---|
| | Equipment |
| Loan Currency | Euro |
| Interest | |
| Interest Type | Variable |
| | Interest Rate |
| Basis Points | Libor + 100 |
| Interest p.a. - % | N/a |
| Interest Calc. Method | Standard |
| No. of Month Interest paid in | 6 |
| Arrears | |
| % of Interest Capitalized | 0% |
| Fees | |
| Management Fee % | 1% |
| Arrangement Fee % | n/a |
| Commitment fee % | 0.25% |
| No. of Month Commitment Fee is | 3 |
| paid in Arrears | |
| Debt Service Reserve Account | |
| Disbursement Phase DSRA - % | 100% |
| of next Debt Service | |
| Repayment Phase DSRA - % of | 100% |
| next Debt Service | |
| Interest Type DSRA | Variable |
| | Interest Rate |
| Basis Points | Libor − 100 |
| Interest on DSRA - % p.a. | N/a |
| Monthly Step-ups | TRUE |
| Financing | |
| Capex - Type/Manual | Equipment |
| Contract | Distillation |
| | Plant |
| Category | Total |
| | Expenditure |
| % of Payments Financed | 100% |
| Disbursement Schedule | |
| Month of Loan Effectiveness | 1 |
| First Disbursement Month | 2 |
| Last Disbursement Month | 30 |
| Repayment | |
| Repayment Method | Equal |
| | Installments |
| Sweep | FALSE |
| Last Month Capit. of Interest | N/a |
| Month - Start Repayment Phase | 30 |
| First Repayment Month | 36 |
| No. of Installments | 15 |

Stand-by Loans

| | |
|---|---|
| Stand - by Loan Construction Phase | USD |
| Maximum Amount | 10,000,000 |
| Interest Type | Variable Interest Rate |
| Basis points | Libor − 100 |
| % Interest p.a. | n/a |
| Stand - by Loan Repayment Phase | USD |
| Maximum Amount | 9,000,000 |
| Last Disbursement Month Stand-by Repayment | 96 |
| Phase | |
| Interest Type | Variable Interest Rate |
| Basis points | Libor − 100 |
| % Interest p.a. | n/a |

Sweep

| | |
|---|---|
| % of Cash Flow | 0% |
| Month - Start Sweep | n/a |
| Month - End Sweep | n/a |

Paid in Capital—Equity

| Project Month | Capital Paid in this Month - USD |
|---|---|
| 1 | 30,000,000 |
| 2 | |
| 3 | |
| 4 | |
| 5 | |
| 6 | |
| 7 | |
| 8 | |
| 9 | |
| 10 | |
| 11 | |
| 12 | |
| 13 | |
| 14 | 10,000,000 |
| 15 | 10,000,000 |
| 16 | 19,000,000 |
| 17 | 2,000,000 |
| 18 | 2,900,000 |
| 19 | 2,900,000 |
| 20 | 5,000,000 |
| 21 | 6,000,000 |
| 22 | 5,000,000 |
| 23 | 3,000,000 |
| 24 | 3,000,000 |
| 25 | 2,500,000 |
| 26 | 2,500,000 |
| 27 | 2,000,000 |
| 28 | 1,600,000 |
| 29 | 90,000,000 |
| 30 | 45,000,000 |
| Total | 242,400,000 |

Dividends

| | |
|---|---|
| % - Dividend | 100% |
| Payments | Quarterly |
| First Dividend Month | 42 |
| Minimize Additional Shareholder Investment | False |

Subsidies

| Manual Entry of Subsidies | n/a |
|---|---|
| Automatic Entry of Subsidies | n/a |
| Start Subsidy - Month | n/a |
| Last Subsidy - Month | n/a |
| Subsidy p.a. | 0 |

Taxes

Corporate Tax

| Manual Tax Rate Entry | FALSE |
|---|---|
| Automatic Tax Rate Entry | TRUE |
| % - Tax Rate retained Income | 20% |
| % - Tax Rate disbursed Income | 30% |
| Tax Payment | Quarterly |
| Tax Holiday - Until Project Month | 30 |
| % - Tax Rate retained Income during | 0% |
| Holiday | |
| % - Tax Rate Disb. Income during | 0% |
| Holiday | |
| Years - Carry forward Losses | 5 |

Property Tax

| | |
|---|---|
| Manual Tax Rate Entry | n/a |
| Automatic Tax Rate Entry | n/a |
| % - Property Tax Rate | 0% |
| Tax Payment | n/a |
| Tax Holiday - Until Project Month | n/a |
| % - Tax Rate during Holiday | n/a |

Depreciation

| | | | | Interest |
|---|---|---|---|---|
| | | | Pre-Prod. | During |
| Capex Category | Buildings | Equipment | Exp. | Constr. |
| Reinvestment | TRUE | TRUE | FALSE | FALSE |
| Linear Depreciation - Years | 20 | 8 | 5 | 5 |
| Reinvestment % of Capex | 0.50% | 2% | n/a | n/a |
| First Reinvestment - Years | 6 | 4 | n/a | n/a |
| after Start-up | | | | |
| Last Reinvestment - Years | 15 | 15 | n/a | n/a |
| after Start-up | | | | |
| No. of Months between | 36 | 24 | n/a | n/a |
| Reinvestments | | | | |

Overheads

Maintenance

| Maintenance Category | Site | Buildings | Equipment |
|---|---|---|---|
| Method - % of Capex | TRUE | TRUE | TRUE |
| Method - Manual | FALSE | FALSE | FALSE |
| % of Capex | 0.50% | 1% | 2.50% |
| Manual - Numeraire | n/a | n/a | n/a |
| Increase - % p.a. | 0% | 0% | 0.50% |
| First Month Maintenance Inc. | n/a | n/a | 120 |
| Last Month Maintenance Inc. | n/a | n/a | 210 |

Administration Factory Overheads and Insurance

| | Administrative | Factory | |
|---|---|---|---|
| | Costs | Overheads | Insurance |
| Currency | USD | USD | USD |
| Cost p.a. at Prices Current at | 1,000,000 | 3,000,000 | 1,000,000 |
| Project Start | | | |
| Cost Increase p.a. - % | 0% | 0% | 0% |
| First Month Cost Increase | n/a | n/a | n/a |
| Last Month Cost Increase | n/a | n/a | n/a |

Fixed Operating Costs

Enter for Main Product Gasoline

| | | | | | |
|---|---|---|---|---|---|
| | | Cost p.a. | | First | Last |
| Fixed Operating | | Project | Cost Inc. | Month | Month |
| Cost | Currency | Start | p.a. - % | Increase | Increase |

Three shifts

| | | | | | |
|---|---|---|---|---|---|
| Supervisors | USD | 180,000 | 0% | N/a | n/a |
| First Operators | USD | 140,000 | 0% | N/a | n/a |
| Operators | USD | 360,000 | 0% | N/a | n/a |
| Laboratory | USD | 130,000 | 0% | N/a | n/a |

Only Daytime

| | | | | | |
|---|---|---|---|---|---|
| Chief Engineer | USD | 70,000 | 0% | N/a | n/a |
| Process engineer | USD | 60,000 | 0% | N/a | n/a |
| Lab Technicians | USD | 110,000 | 0% | N/a | n/a |
| Plumbers | USD | 90,000 | 0% | N/a | n/a |
| Electricians | USD | 90,000 | 0% | N/a | n/a |

Variable Costs

Enter for Main Product Gasoline—Determined in Input Market

| Name | Electricity | Water | Lubricant |
|---|---|---|---|
| Unit of Measurement | Kwh | Cbm | Tons |
| Input-Output Coeff. | 12.2 | 1 | 0.05 |
| Minimum Stock | 0 | 0 | 100 |
| Delivery Time | 0 | 0 | 30 |
| Currency | USD | USD | Euro |
| Price/Unit of Input | 0.15 | 0.05 | 50 |
| Input Price Trend p.a. | 0% | 0% | 0% |
| First Month Trend | n/a | n/a | n/a |
| Last Month Trend | n/a | n/a | n/a |
| % Price Swings | 0% | 0% | 0% |
| Months Length of Cycle | n/a | n/a | n/a |
| Cycle at Project Start | n/a | n/a | n/a |
| Down Payment | 0 | 0 | 15% |
| Avg. Days before Paym. | 30 | 0 | 0 |

Enter for Gasoline—Prices Determined by Output Market

| Name | Crude Oil Procurement |
|---|---|
| Unit of Measurement | Barrel |
| Input-Output Coeff. | 1.66666 |
| Minimum Stock | 5,000 |
| Delivery Time | 1 |
| Trigger Price Deferral - USD | 35 |
| % deferred | 50% |
| Max. Amount deferred | 10,000,000 |
| Interest Rate Type | Variable Interest Rate |
| Basis Points | Libor - 100 |
| Sales Contract | Domestic Sales |
| Currency | USD |
| Cost/Unit as % of Sales Price | 57% |
| Minimum Price/Unit Input (USD) | 12 |
| % - Minimum Price increase p.a. | 0% |
| First Month Trend | n/a |
| Last Month Trend | n/a |
| Down Payment | 15 |
| Avg. Days before Paym. | 28 |

Sales—Off-take Contracts

Gasoline

| Off-take Contract Data | | |
|---|---|---|
| Product | Gasoline | Gasoline |
| Contract | Domestic Sales | South American |
| | | Sales |
| Contract Currency | USD | Pesos |
| Share of Contract | 50% | 50% |
| Avg. No. Days before | 20 | 20 |
| Receipt of Payment | | |
| Automatic Price | TRUE | TRUE |
| Price per Unit | 50 | 455 |
| Sales Price Trend p.a. | 0% | 0% |
| First Month Trend | n/a | n/a |
| Last Month Trend | n/a | n/a |
| % Price Swings | 0% | 0% |
| Months - Length of Cycle | n/a | n/a |
| Cycle at Project Start | n/a | n/a |
| Sales Expenses Company | | |
| Currency Transport Cost | USD | USD |
| Transport Cost/Unit | 5 | 5 |
| % Cost Increase p.a. | 0% | 0% |
| First Month Transport Cost | n/a | n/a |
| Increase | | |
| Last Month Transport Cost | n/a | n/a |
| Increase | | |
| Currency Insurance | USD | USD |
| Insurance Cost/Unit | 1 | 1 |
| % Cost increase p.a. | 0% | 0% |
| First Month Insurance Cost | n/a | n/a |
| Increase | | |
| Last Month Insurance Cost | n/a | n/a |
| Increase | | |
| Sales Expenses Off-Taker | | |
| Currency Transport Cost | USD | Pesos |
| Transport Cost/Unit | 5 | 30 |
| % Cost Increase p.a. | 0% | 0% |
| First Month Transport Cost | n/a | n/a |
| Increase | | |
| Last Month Transport Cost | n/a | n/a |
| Increase | | |
| Currency Insurance | USD | Pesos |
| Insurance Cost/Unit | 1 | 10 |
| % Cost Increase p.a. | 0% | 0% |
| First Month Insurance Cost | n/a | n/a |
| Increase | | |
| Last Month Insurance Cost | n/a | n/a |
| Increase | | |
| Fees | | |
| Handling Fee - % | 5% | 5% |
| Flat Fee p.a. | 0 | 0 |
| % Flat Fee Increase p.a. | 0% | 0% |
| First Month Flat Fee | n/a | n/a |
| Increase | | |
| Last Month Flat Fee | n/a | n/a |
| Increase | | |
| Taxes and Duty | | |
| Indirect Tax - % | 0% | 0% |
| Duty | 0% | 0% |
| % Handling Fee deferred | 50% | 50% |
| % Flat fee deferred | n/a | n/a |
| Trigger Price | | Pesos 250 |
| Max. amount deferred | USD 2,000,000 | Pesos 20,000,000 |
| Interest Type | Variable Interest Rate | Fixed Interest Rate |
| Basis Points, Interest Rate | Libor - 100 | 3% |

Diesel

| Off-take Contract Data | |
|---|---|
| Product | Diesel |
| Contract | Diesel Sales |
| Contract Currency | USD |
| Share of Contract | 100% |
| Avg. No. Days before Receipt of | 20 |
| Payment | |
| Automatic Price | TRUE |
| Price per Unit | 50 |
| Sales Price Trend p.a. | 0% |
| First Month Trend | n/a |
| Last Month Trend | n/a |
| % Price Swings | 0% |
| Months - Length of Cycle | n/a |
| Cycle at Project Start | n/a |
| Sales Expenses Company | |
| Currency Transport Cost | USD |
| Transport Cost/Unit | 5 |
| % Cost Increase p.a. | 0% |
| First Month Transport Cost Increase | n/a |
| Last Month Transport Cost Increase | n/a |
| Currency Insurance | USD |
| Insurance Cost/Unit | 1 |
| % Cost Increase p.a. | 0% |
| First Month Insurance Cost Increase | n/a |
| Last Month Insurance Cost Increase | n/a |
| Sales Expenses Off-Taker | |
| Currency Transport Cost | USD |
| Transport Cost/Unit | 10 |
| % Cost Increase p.a. | 0% |
| First Month Transport Cost Increase | n/a |
| Last Month Transport Cost Increase | n/a |
| Currency Insurance | USD |
| Insurance Cost/Unit | 1 |
| % Cost Increase p.a. | 0% |
| First Month Insurance Cost Increase | n/a |
| Last Month Insurance Cost Increase | n/a |
| Fees | |
| Handling Fee - % | 5% |
| Flat Fee p.a. | 0 |
| % Flat Fee Increase p.a. | n/a |
| First Month Flat Fee Increase | n/a |
| Last Month Flat Fee Increase | n/a |
| Taxes and Duty | |
| Indirect Tax - % | 0% |
| Duty | 0% |
| % Handling Fee deferred | 50% |
| % Flat fee deferred | n/a |
| Trigger Price | USD 45 |
| Max. amount deferred | USD 2,000,000 |
| Interest Type | Fixed Interest Rate |
| % Interest on deferred Amount | 3% |

Bitumen

| | |
|---|---|
| Off-take Contract Data | |
| Product | Bitumen |
| Contract | Bitumen Sales |
| Contract Currency | USD |
| Share of Contract | 100% |
| Avg. No. Days before Receipt of | 20 |
| Payment | |
| Automatic Price | TRUE |
| Price per Unit | 25 |
| Sales Price Trend p.a. | 0% |
| First Month Trend | n/a |
| Last Month Trend | n/a |
| % Price Swings | 0% |
| Months - Length of Cycle | n/a |
| Cycle at Project Start | n/a |
| Sales Expenses Company | |
| Currency Transport Cost | USD |
| Transport Cost/Unit | 5 |
| % Cost Increase p.a. | 0% |
| First Month Transport Cost Increase | n/a |
| Last Month Transport Cost Increase | n/a |
| Currency Insurance | USD |
| Insurance Cost/Unit | 1 |
| % Cost Increase p.a. | 0% |
| First Month Insurance Cost Increase | n/a |
| Last Month Insurance Cost Increase | n/a |
| Sales Expenses Off-Taker | |
| Currency Transport Cost | USD |
| Transport Cost/Unit | 5 |
| % Cost Increase p.a. | 0% |
| First Month Transport Cost Increase | n/a |
| Last Month Transport Cost Increase | n/a |
| Currency Insurance | USD |
| Insurance Cost/Unit | 1 |
| % Cost Increase p.a. | 0% |
| First Month Insurance Cost Increase | n/a |
| Last Month Insurance Cost Increase | n/a |
| Fees | |
| Handling Fee - % | 5% |
| Flat Fee p.a. | 10,000 |
| % Flat Fee Increase p.a. | 0% |
| First Month Flat Fee Increase | N/a |
| Last Month Flat Fee Increase | N/a |
| Taxes and Duty | |
| Indirect Tax - % | 0% |
| Duty | 0% |
| Deferral | |
| % Handling Fee deferred | 50% |
| % Flat fee deferred | 50% |
| Trigger Price | USD 10 |
| Max. Amount deferred | USD 1,000,000 |
| Interest Rate Type | Variable Interest Rate |
| Basis Points | Libor - 100 |

The foregoing disclosure has been set forth merely to illustrate the invention and s not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for automatically generating variable interest rate time series to allow for simulating interest rate shock or cyclical patterns, automatically adding or subtracting basis points across the board from each element of the time series and manually editing the time series to give access to the variable interest rate.

2. The computer program product as claimed in claim 1, wherein the program code generates a graphical user interface at a workstation.

3. The computer program product as claimed in claim 1, wherein said access means include the creation of a link between a loan, a stand-by loan, a deferral credit for input payments, deferral credits for off-taker fees, and the variable interest rate and at the same time ensuring that the loan interest rate or deferral credit interest rate is changed according to changes in the variable interest rate with such changes taking place at appropriate rollover dates.

4. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for allowing a user, with regard to a loan, stand-by loan, deferral credit for input payments and deferral credit for off-taker fees, to select a fixed interest rate and a variable interest rate and, with respect to a loan, to select a manual interest rate such that the user, in case of a variable interest rate selection, is allowed to input basis points to add or subtract from the variable interest rate, and thereby to establish a link between the loan and the variable interest rate time series and, in case of manual interest rate selection, to gain access to entry fields manually to set interest rate at appropriate rollover dates.

5. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for allowing inputting of input-output coefficients for requirement of intermediate products and automatically generating time series for amount of intermediate product to be used as input for next stage with remainder being sold outside, and manually editing said time series, and at the same time permitting a user to generate an output time series for each production stage for end product with output time series in case of multi stage production process outlining a potential production frontier.

6. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for using and displaying graphically intermediate product as input in a next production stage and preventing, if so desired, any shortfall of intermediate product and consequently shortfall of output of next production stage through outside procurement of intermediate product, allowing a production frontier to be reached.

7. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for selling output or portions thereof of at least one of intermediate or end product.

8. A financial simulation computer program product for creating a project preparation, negotiating, and testing environment using standard project finance tools, comprising:
a computer usable medium having computer-readable program code embodied in a medium for generating financial statements, financial data, charts, graphs and reports using the standard project finance tools, the product having
means for providing limited recourse including debt service reserve accounts, stand-by loans and risk-sharing with suppliers and off-takers;
means for allowing automatically generated or manual entry of and editing of capital expenditure time series for multiple contracts in multiple capital expenditure categories;
means for selecting a desired financing time horizon for each loan;
means for setting for each loan a percentage of a capital expenditure time series to be financed;
means for automatically generating a loan disbursement time series; and
means for generating a loan disbursement times series independent of changes in capital expenditures and exchange rates based upon an earlier automatically generated loan disbursement time series, and
means for jointly producing a main product and additional products in a production stage and selling output or portions thereof with respect to at least one of a jointly produced product and a main product.

9. The computer program product as claimed in claim 8, further including means for allowing the user to input a number of units of additional products being produced per unit of main product and a percentage of production cost being allocated to each joint product while automatically ensuring that production costs not allocated to joint products are allocated to the main product.

10. The computer program product as claimed in claim 5, wherein means is provided for automatically building inventory for intermediate and end products.

11. The computer program product as claimed in claim 10, wherein said inventory building means includes the step of, upon entry of the number of units held as minimum stock and delivery time, buying minimum stock on time for delivery at start-up to begin production.

12. The computer program product as claimed in claim 11, wherein said inventory building means values stock with a LIFO-method.

13. The computer program product as claimed in claim 1, wherein means is provided for allowing cash flow risks to be shared with a supplier for both intermediate and end products.

14. The computer program product as claimed in claim 13, wherein said cash flow risks sharing means includes, upon selection of a sales contract and inputting of a percentage to be applied to a sales price of the selected sales contract to obtain input price, establishing a link between the sales contract and the input price and entering the name of the selected sales contract into a variable input record to allow the input price in numéraire units to vary subject to a minimum price time series with the sales price time series and an associated exchange rate time series.

15. The computer program product as claimed in claim 1, wherein means is provided to allow inputting of input-output coefficients and to select a time needed to produce one output unit per product for both intermediate and end products.

16. The computer program product as claimed in claim 15, wherein said time selection means includes accounting for the number of units produced, prices work-in-process at factor costs, and accounting for changes in input costs.

17. The computer program product as claimed in claim 16, wherein the work-in-process is priced at historical cost at time of procurement of input factors plus share of fixed operating costs during production time.

18. The computer program product as claimed in claim 1, wherein means is provided for creating a cash flow, an income statement and a balance sheet which will account for output variations including maintenance shutdowns for both intermediate and end products.

19. The computer program product as claimed in claim 18, wherein said balance sheet creating means includes means for creating a finished goods balance sheet position based upon an average number of inventory cycle days, whereby a value of finished goods is generatable at any time during a project lifetime.

20. The computer program product as claimed in claim 1, wherein means is provided for allowing sale of output or portions thereof directly to an end user, through intermediaries (off-takers) or on a cost-plus basis taking sales expenses into account for intermediate and end products as well as for joint products.

21. The computer program product as claimed in claim 1, wherein means is provided to check dynamic impact of changes in key variables on limited recourse reserve availability, said dynamic impact checking means allows, with regard to a selected product, access to at least one of deferment credits variable costs, unused variable cost recourse, deferment credits off-take contracts, unused off-take credit recourse and total unused product recourse.

22. The computer program product as claimed in claim 1, wherein said entry allowance means includes inputting multiple variables per product for both intermediate and end products.

23. The computer program product as claimed in claim 1, wherein means is provided for user inputting down payment for variable input factor payments and time between creation of payment obligation and actual payment for both intermediate and end products.

24. The computer program product as claimed in claim 23, wherein said user input means allow calculation of variable input factor related cash payments, impact on cash account and accounts payable.

25. The computer program product as claimed in claim 14, wherein means is provided for deferral credit of input payments subject to a trigger price and a maximum loan deferral amount not yet used, and paying interest on utilization of a deferral credit, and deferring interest payment if cash flow is unavailable.

26. The computer program product as claimed in claim 1, wherein the output time series is automatically generated using percentage of capacity used and including automatic creation of linear, steep and flat learning curves and allowing for manually editing time series of percentage of capacity used including the creation of maintenance shutdowns for both intermediate and end products.

27. The computer program product as claimed in claim 7, wherein means is provided for allowing sale of output or portions thereof directly to an end user, through intermediaries (off-takes) or on a cost-plus basis taking sales expenses into account for intermediate and end products.

28. The computer program product as claimed in claim 27, wherein said cost-plus sale allowing means includes providing a list of cost basis comprising cost of goods sold, cost of goods sold plus share in overheads and cost of goods sold plus share in overheads plus share in depreciation.

29. The computer program product as claimed in claim 28, wherein said sale allowing means further includes the step, upon selection of a mark-up basis, of establishing a link between a mark-up sales price and a selected cost basis, whereby any changes in the selected cost basis are automatically associated with the mark-up price.

30. The computer program product as claimed in claim 7, wherein means is provided to check dynamic impact of changes in key variables on limited recourse reserve availability, said dynamic impact checking means allows, with regard to a selected product, access to at least one of deferment credits variable costs, unused variable cost recourse, deferment credits off-take contracts, unused off-take credit recourse and total unused product recourse.

31. The computer program product as claimed in claim 7, wherein said entry allowance means includes inputting multiple variables per product for both intermediate and end products.

32. The computer program product as claimed in claim 7, wherein said entry allowance means includes means for inputting different types of sales contracts per product for both intermediate and end products.

33. The computer program product as claimed in claim 20, wherein said direct sale or sale through intermediaries allows automatic generation of the sales price time series including cyclical patterns and trends and allows the manual editing of the sales price time series for both intermediate and end products.

34. The computer program product as claimed in claim 33, wherein means is provided for cash flow risk sharing with intermediaries (off-takers) through deferral credits for off-takers' fees subject to a trigger price, a maximum deferral credit amount not yet reached and paying interest on utilization of a deferral credit, and deferring interest payment if cash flow is unavailable.

35. The computer program product as claimed in claim 20, wherein means is provided for allowing user input of time between creation of sales payment obligation and receipt of payment for intermediate and end products as well as main and joint products.

36. The computer program product as claimed in claim 35, wherein said time between creation of payment obligation and receipt of payment includes calculation of balance sheet position receivables.

37. The computer program product as claimed in claim 7, wherein means is provided for searching, upon a user initialized deletion of a direct sale or off-take contract, all individual records of variable input factors using a percentage of sales price for input factor pricing and, finding the direct sale or off-take contract's name in one record, prevents the deletion of the direct sale or off-take contract for both intermediate and end products.

38. The computer program product as claimed in claim 8, wherein means is provided for allowing sale of output or portions thereof directly to an end user, through intermediaries (off-takers) or on a cost-plus basis taking sales expenses into account for both jointly produced and main products.

39. The computer program product as claimed in claim 38, wherein said cost-plus sale allowing means includes providing a list of cost bases comprising a share of total operating costs, a share of variable costs, a share of fixed operating costs, a share of variable plus fixed operating costs, and a share of total operating costs plus depreciation.

40. The computer program product as claimed in claim 39, wherein said sale allowing means further includes the step, upon selection of a mark-up basis, of establishing a link between a mark-up sales price and a selected cost basis, whereby any changes in the selected cost basis are automatically associated with the mark-up price.

41. The computer program product as claimed in claim 8, wherein means is provided to check dynamic impact of changes in key variables on limited recourse reserve availability for both jointly produced and main products, said dynamic impact checking means allows, with regard to a selected product, access with respect to main products to at least one of deferment credits variable costs and unused variable cost recourse, and with respect to main and joint products access to at least one of deferment credits off-take contracts, unused off-take credit recourse and total unused product recourse.

42. The computer program product as claimed in claim 8, wherein said entry allowance means includes inputting variables for jointly produced and main products.

43. The computer program product as claimed in claim 8, wherein said entry allowance means includes means for inputting different types of sales contracts per product for jointly produced and main products.

44. The computer program product as claimed in claim 41, wherein said direct sale or sale through intermediaries allows automatic generation of the sales price time series including cyclical patterns and trends and allows the manual editing of the sales price time series for both jointly produced and main products.

45. The computer program product as claimed in claim 44, wherein means is provided for cash flow risk sharing with intermediaries (off-takers) through deferral credits for off-takers' fees subject to a trigger price, a maximum deferral credit amount not yet reached and paying interest on utilization of a deferral credit, and deferring interest payment if cash flow is unavailable.

46. The computer program product as claimed in claim 42, wherein means is provided for allowing user input of time between creation of sales payment obligation and receipt of payment for both jointly produced and main products.

47. The computer program product as claimed in claim 8, wherein means is provided for searching, upon a user initialized deletion of a direct sale or off-take contract, all individual records of variable input factors using a percentage of sales price for input factor pricing and, finding the direct sale or off-take contract's name in one record, prevents the deletion of the direct sale or off-take contract for both jointly produced and main products.

48. Method for implementing a machine-readable financial simulation computer program, comprising:
installing the program which is contained as computer readable code on a computer usable medium in a computer;
permitting entry of data representative of multiple contracts and multiple capital expenditure categories;
selecting a desired loan financing time horizon;
setting a percentage of a capital expenditure time series to be financed;
generating a loan disbursement time series and disbursement schedule independent of changes in capital expenditures and in exchange rates; and
automatically generating and manually editing variable interest rate time series to permit automatic across-the-board changes and a simulation of cyclical patterns and shocks.

49. Method for implementing a machine-readable financial simulation computer program, comprising:
installing the program which is contained as computer readable code on a computer usable medium in a computer;
permitting entry of data representative of multiple contracts and multiple capital expenditure categories;
selecting a desired loan financing time horizon;
setting a percentage of a capital expenditure time series to be financed;
generating a loan disbursement time series and disbursement schedule independent of changes in capital expenditures and in exchange rates; and
selecting one of fixed, variable and manual interest rate while, in case of variable interest rate, creating a link between loan and variable interest rate and ensuring change of a loan interest rate at an appropriate rollover date with basis points added or subtracted as user inputs and, in case of manual interest rate selection, gaining access to entry fields to set manually interest rate at appropriate rollover dates not allowing changes between such dates.

50. Method for implementing a machine-readable financial simulation computer program, comprising:
installing the program which is contained as computer readable code on a computer usable medium in a computer;
permitting entry of data representative of multiple contracts and multiple capital expenditure categories;
selecting a desired loan financing time horizon;
setting a percentage of a capital expenditure time series to be financed;
generating a loan disbursement time series and disbursement schedule independent of changes in capital expenditures and in exchange rates; and
inputting input-output coefficients for requirements of intermediate products and automatically generating time series for amount of intermediate product to be used as input for next stage with remainder being sold outside and manually editing said time series and at the same time user being permitted generating output time series for each production stage selectively for end product or for intermediate products.

51. The method as claimed in claim 50, further comprising automatically building inventories for end and intermediate products.

52. The method as claimed in claim 50, further comprising allowing cash flow risks to be shared with a supplier for end and intermediate products.

53. The method as claimed in claim 50, further comprising allowing selection of a time needed to produce one output unit for end and intermediate products.

54. The method as claimed in claim 50, further comprising creating a cash flow income statement and a balance sheet which accounts for output variations including maintenance shutdowns for end and intermediate products.

55. The method as claimed in claim 50, further comprising allowing sale of output or portions thereof on a cost-plus basis for end and intermediate products.

56. The method as claimed in claim 52, further comprising checking dynamic impact of changes in key variables on limited recourse reserve availability for multistage production processes using intermediate products to produce an end product.

57. The method as claimed in claim 50, further comprising inputting multiple variables per product for end and intermediate products.

58. The method as claimed in claim 50, further comprising inputting different types of sales contracts per product for end and intermediate products.

59. The method as claimed in claim 50, further comprising break-even testing a sales contract for end and intermediate products.

60. Method for implementing a machine-readable financial simulation computer program, comprising:
installing the program which is contained as computer readable code on a computer usable medium in a computer;
permitting entry of data representative of multiple contracts and multiple capital expenditure categories;
selecting a desired loan financing time horizon;
setting a percentage of a capital expenditure time series to be financed;
generating a loan disbursement time series and disbursement schedule independent of changes in capital expenditures and in exchange rates; and
inputting units of joint products produced per unit of main product and production cost allocated to joint products and automatically allocating remainder of production costs to main product which permitting to use to generate output time series for each main or joint product.

61. The method as claimed in claim 60, further comprising automatically building inventories for main and joint products.

62. The method as claimed in claim 60, further comprising allowing cash flow risks to be shared with a supplier for main and joint products.

63. The method as claimed in claim 60, further comprising allowing selection of a time needed to produce one output unit of main product, the number of joint units produced per unit of main product being the number of joint units produced during the selected time to produce the one output unit.

64. The method as claimed in claim 60, further comprising creating a cash flow income statement and a balance sheet which accounts for output variations including maintenance shutdowns for main and joint products.

65. The method as claimed in claim 60, further comprising allowing sale of output or portions thereof on a cost-plus basis for main and joint products.

66. The method as claimed in claim 60, further comprising checking dynamic impact of changes in key variables on limited recourse reserve availability for main and joint products in connection with production of joint and main products.

67. The method as claimed in claim 60, further comprising inputting multiple variables per product for main and joint products.

68. The method as claimed in claim 60, further comprising inputting different types of sales contracts per product for main and joint products.

69. The method as claimed in claim 60, further comprising break-even testing a sales contract for main and joint products.
